(19) United States
(12) Patent Application Publication
(10) Pub. No.: US 2024/0429854 A1
(43) Pub. Date: Dec. 26, 2024

(54) SOLAR TRACKER SUPPORT SYSTEM AND INSTALLATION APPARATUS

(71) Applicant: SPINEX SYSTEMS, INC., Aiken, SC (US)

(72) Inventors: Kym Anthony Plotkin, Ormeau (AU); Alex Au, Aiken, SC (US)

(73) Assignee: SPINEX SYSTEMS, INC., Aiken, SC (US)

(21) Appl. No.: 18/700,990

(22) PCT Filed: Oct. 14, 2022
(86) PCT No.: PCT/AU2022/051234

§ 371 Date: Apr. 12, 2024

Related U.S. Application Data
(60) Provisional application No. 63/256,169, filed on Oct. 15, 2021.
(60) Provisional application No. 63/290,738, filed on Dec. 17, 2021.

(51) Int. Cl. H02S 20/32; E02D 5/56; E02D 27/32; H02S 20/10

(52) U.S. Cl. CPC H02S 20/32; E02D 5/56; E02D 27/32; H02S 20/10

(57) ABSTRACT

A support for a solar tracker support system includes two screw piles or blade piles (41, 42) inserted into the ground, the two screw piles or blade piles (41, 42) being spaced from the longitudinal axis of the solar tracker, and an upper support (111A) having a first leg and a second leg and an upper region interconnecting the first leg to the second leg, the first leg mounted to a first pile of the two screw piles or blade piles (41, 42) and extending upwardly therefrom, the second leg mounted to a second pile of the two screw piles or blade piles (41, 42) and extending upwardly therefrom

### TECHNICAL FIELD

The present invention relates to a solar tracker support system and an installation apparatus.

### BACKGROUND ART

Many large-scale solar farms utilise solar trackers so that the photovoltaic solar panels move during the day to remain more closely aligned with the position of the sun. This increases electricity production from the solar panels.

Solar trackers in large-scale solar farms typically comprise an array of solar panels or a series of solar panels mounted to a long torque tube or a series of torque tubes that are in alignment with each other. A drive motor rotates the torque tube(s), which, of course, causes the solar panels to rotate with the torque tube to closely follow the sun as the sun moves across the sky during the day. The torque tube is normally supported on or suspended from a number of spaced support members and it is necessary to accurately position the support members in order to ensure that the torque tube is in alignment and that rotation of the torque tube can occur.

There are a variety of piles that have been utilized for the support of solar trackers, particularly single axis solar trackers. In some instances, I or H-beams are employed, and these beams are driven into the ground to a desired depth. An example of such a beam can be seen in FIG. 1. After installation of the beams in the earth, a bearing assembly is connected thereto with a variety of bolts. The beam and the bearing typically include some means of adjusting the bearing relative to the beam to allow misalignments to be corrected.

In other instances, screw piles have been devised that with the use of special screw machinery can be screwed into the earth to a desired depth. These screw piles typically employ a helical screw thread that wraps around a portion of the centre post of the pile.

While both traditional I or H-beam piles and screw piles are generally they do create challenges for the industry. For I or H-beam piles there is quite a bit of effort and labour expended on proper installation and then subsequent mounting and alignment of the bearings. For screw piles alignment can also be a challenge, particularly where two or more screw piles are employed to support a single bearing. Each of these must be aligned with each other, and then with the remaining piles of the solar tracker. Moreover, the bearing still needs to be fitted and aligned with other bearings in the solar tracker.

One of the present inventors devised a support being system and structure for supporting solar trackers and intended for use in a solar farm that was being developed in Moree in the Australian state of New South Wales in 2014. FIG. 1 shows a schematic view of this proposal. The solar tracker system shown in FIG. 1 has a torque tube 10 passing through and supported by bearings 11. A plurality of spaced supports are provided to support the bearings 11 and, in turn, the torque tube 10. A central support 12 comprises four screw piles or blade piles 13, 14, 15, 16. The central support 12 supports the motor that drives the torque tube. The blade piles are available from Blade Pile Pty Ltd and may be as described in Australian innovation patent number 2011100820. The screw piles or blade piles 13, 14, 15, 16 are inserted or drilled into the ground at an angle to vertical. A top plate 17 is mounted to the top of each of the screw piles 13, 14, 15, 16. The top plate 17 acts to tie the tops of the screw piles 13, 14, 15, 16 together and also provides a mounting surface for an upright 18 that carries motor 19.

A number of other supports are also provided to support the torque tube. These other supports are spaced from each other and are essentially identical. The other supports, one of which is shown at 20, includes a first blade pile 21 screwed into the ground at an angle to vertical and a second blade pile 22 screwed into the ground at an angle to vertical. The tops of the blade piles 21, 22 are spaced very close to each other or even in abutment with each other. A top gusset plate 23 is connected to the tops of the blade piles 21, 22. An upright 24 holds the bearing 11 which, in turn, receives the beam 10. Thus, support structure 20 forms an A-frame structure that resists bending in a direction transverse to the longitudinal axis of the beam 10, which is very desirable in solar trackers, as wind forces on the solar panels tend to produce strong forces transverse to the longitudinal axis of the tracker.

Although this design showed great promise at the conceptual stage, testing revealed several difficulties with this design. The piles were installed on an angle in-ground. This has the potential to cause difficulties in ensuring that the piles are properly aligned and have the correct angle. There was concern that the top of pile connections and adjustments would be pushed beyond their connection/fasting range capability due to installation tolerance issues with this design. Further, the angled piles will be structurally stressed and compromised by the seasonal forces of vertical heaving and shrinking hydraulic soils. This issue will be greater in sites that are subject to frost heave forces.

Consequently, there remains a need to provide an improved support structure for solar trackers.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a support system for solar trackers, which may at least partially overcome at least one of the abovementioned disadvantages or provide the consumer with a useful or commercial choice.

In a first aspect, the present invention provides a support system for a solar tracker including a plurality of supports spaced from each other and extending along a longitudinal axis of the solar tracker, the supports including two screw piles or blade piles inserted into the ground, the two screw piles or blade piles being spaced from the longitudinal axis of the solar tracker, a first support mounted to a first pile of the two screw piles or blade piles and extending upwardly therefrom, a second support mounted to a second pile of the two screw piles or blade piles and extending upwardly therefrom, an upper region of the first support extending inwardly towards the longitudinal axis of the solar tracker, an upper region of the second support extending inwardly towards the longitudinal axis of the solar tracker, and a connector connecting the upper end of the first support to the upper end of the second support.

In a second aspect, the present invention provides a support for a solar tracker support system, the support including two screw piles or blade piles inserted into the ground, the two screw piles or blade piles being spaced from the longitudinal axis of the solar tracker, a first support mounted to a first pile of the two screw piles or blade piles and extending upwardly therefrom, a second support mounted to a second pile of the two screw piles or blade piles and extending upwardly therefrom, an upper region of the first support extending inwardly towards the longitudinal axis of the solar tracker, an upper region of the second support extending inwardly towards the longitudinal axis of the solar tracker, and a connector connecting the upper end of the first support to the upper end of the second support.

In one embodiment, the screw piles or blade piles are inserted substantially vertically into the ground.

In one embodiment, the upper region of the first support and the second support comprises an essentially straight region. The upper region of the first support and the second support may comprise a significant extent of the first support and the second support.

In one embodiment, the first support comprises a lower region having an open lower end, the lower region extending in a generally vertical direction, the lower region being located over an upper end of the first pile, the first support extending upwardly and inwardly from the lower region, and the second support comprises a lower region having an open lower end, the lower region extending in a generally vertical direction, the lower region being located over an upper end of the second pile, the second support extending upwardly and inwardly from the lower region. In this embodiment, the lower region may have a cross sectional opening area that is slightly larger than an outer area of the first pile and second pile, and the first support and the second support having a region extending from an upper part of the lower region and extending upwardly and inwardly, the region extending from an upper part of the lower region having a smaller diameter or cross-sectional area than the lower region.

In one embodiment, the first support and the second support comprise a hollow leg having a hollow sleeve joined thereto, the hollow leg extending at a different angle to the hollow sleeve, the hollow sleeve being of larger diameter or cross-sectional area than the hollow leg, the hollow sleeve forming the lower region of the first support and the second support. The hollow sleeve may comprise a steel sleeve that is welded to a hollow steel leg.

In one embodiment, the first support has a lower end that can be received within an open upper end of the first pile and the second support has a lower end that can be received within an open upper end of the second pile. In this embodiment, the first support may comprise a leg having a lower end received within the open upper end of the first pile and the second support may comprise a leg having a lower end received within the open upper end of the second pile. In this embodiment, the first support is oriented so that it extends upwardly and inwardly and the second support is oriented so that it extends upwardly and inwardly. In one embodiment, the lower region of the leg may extend vertically when in the assembled position and the leg extends upwardly and inwardly above the lower region. In one embodiment, a protective boot is placed over the junction between the first pile and the first support and a protective boot is placed over the junction between the second pile and the second support.

In one embodiment, the first support is affixed to the first pile by use of a bolt or a pin and the second support is affixed to the second pile by use of a bolt or a pin.

In one embodiment, the connector comprises a hoop or a loop of material, the hoop or loop carrying a bearing that can receive or support a solar tracker or receive or support a pin for carrying a solar tracker. In one embodiment, the hoop or loop of material is forged. This allows for a strong loop of material to be obtained at a minimum material thickness or material weight.

In one embodiment, the connector comprises a first leg extending at an angle to vertical, the first leg being received within an upper portion of the first support, and a second leg extending at an angle to vertical, the second leg being received within an upper portion of the second support. In this embodiment, the first leg may be crimped or bolted or affixed by other fasteners to the first support and the connector may be crimped or bolted or affixed by other fasteners to the second support.

In one embodiment, the first leg of the connector has a lower region that tapers inwardly or the first leg has an outer part of a lower region removed therefrom, or the first leg has an outer part of a lower region having reduced cross-sectional area at an outer region thereof and the second leg has a lower region that tapers inwardly or the second leg has an outer part of a lower region removed therefrom, or the second leg has an outer part of a lower region having reduced cross-sectional area at an outer region thereof. In this embodiment, insertion of the angled first leg and second leg of the connector into the top portions of the respective first and second supports is facilitated by the tapering lower region or the lower region that has an outer part removed therefrom or the outer part of the lower region having reduced cross-sectional area at an outer region thereof.

In one embodiment, the first leg and the second leg of the connector have one or more ribs thereon, or the first leg and the second leg have alternating regions of larger diameter or cross-sectional area and smaller diameter or cross-sectional area, with shoulders located therebetween. In these embodiments, affixing of the connector to the first and second supports by crimping is enhanced by the ribs or alternating regions of larger diameter/area and smaller diameter/area. It will also be appreciated, that fasteners, such as bolts, screw or rivets, can be used to connect the legs of the connector to the upper parts of the first and second supports.

In one embodiment, the connector comprises a solar tracker support, a base portion connected to or formed with the solar tracker support, and two opposed ears or plates extending downwardly from the base portion, a first ear or plate located to one side of a top portion of the first and second supports, a second ear or plate located to another side of a top portion of the first and second supports, and fasteners extending through the first ear or plate and the second ear or plate to affix the top portion of the first support to the first ear or plate and to the second ear or plate and to affix the top portion of the second support to the first ear or plate and to the second ear or plate. In one embodiment, the fasteners comprise bolts and nuts. In another embodiment, the fasteners comprise screws. In another embodiment, the fasteners comprise rivets. In one embodiment, the first ear or plate and the second ear or plate may be provided with aligned openings for receiving one or more fasteners. The aligned openings may be positioned in alignment with one or more openings formed in the top portions of the first support pile and the second support.

In one embodiment, the connector comprises a solar tracker support, a first sleeve extending downwardly at an angle, a second sleeve extending downwardly at an angle, the first sleeve extending over a top portion of the first support, the second sleeve extending over a top portion of the second support, and fasteners for connecting the first sleeve to the first support and for connecting the second sleeve to the second support. In one embodiment, the solar tracker support comprises a base portion with the first sleeve extending downwardly at an angle from the base portion and the second sleeve extending downwardly at an angle from the base portion. The base portion may comprise a base plate. One or more reinforcing gussets or reinforcing plates may also be provided. The first sleeve and the second sleeve may be provided with aligned openings for receiving fasteners that also pass through openings formed in the top portion of the first and second screw piles or blade piles. In one embodiment, the fasteners comprise bolts and nuts. In another embodiment, the fasteners comprise screws. In another embodiment, the fasteners comprise rivets.

In one embodiment, the connector carries a bracket, the bracket adapted to carry a torque tube mounting arrangement. In one embodiment, the bracket is fastened to the connector and a torque tube mounting arrangement is suspended from a pin or fastener passing through the bracket.

In another embodiment, the connector carries or includes a mounting means for a torque tube mounting arrangement. The mounting means may comprise a hole or an opening. The hole or opening may be formed in the connector or the hole or opening may be formed in a tab or plate attached to the connector. The tab or plate may be welded to the connector.

In another embodiment, the connector is adapted to carry a torque tube mounting arrangement. In one embodiment, the connector includes receiving means for receiving a torque tube swing arm pin. In one embodiment, the connector includes spaced and aligned apertures to receive a torque tube swing arm pin. In one embodiment, the apertures may be provided with bushes, such as nylon bushes, or bearings, to reduce friction between the connector and the torque tube mounting arrangement, or between the connector and the torque tube swing arm pin.

In one embodiment, the screw piles or blade piles comprise a hollow tube having one or more screws or blades affixed thereto. The screw piles or blade piles may include internal drive hubs that receive a drive tool or driveshaft to facilitate installation of the screw piles or blade piles into the ground. Pile lengths, screw sizes, blade sizes and steel thickness will be governed by the given site-specific geotechnical environment and specified loads, as will be understood by persons skilled in the art. In one embodiment, the piles comprise blade piles available from Blade Pile Pty Ltd.

The piles will suitably be made from metal, such as heavy duty metal, such as steel. The steel may be galvanised or rust proofed. The supports are suitably made from metal, such as steel. The steel may be galvanised or rust proofed.

In use, the first support, the second support and the connector may form an A-frame support that is mounted to the ground by the first pile and the second pile.

In one embodiment, the lower end of the first support may allow limited relative rotation between the first support and the first pile in a direction transverse to a longitudinal axis of the solar tracker. In one embodiment, this may be achieved by having the open lower end on the first support having an opening having a larger dimension in the direction transverse to the longitudinal axis than an outside diameter or outside dimension of the shafts of the piles, and the opening of the lower end of the first support having an inner dimension in a direction parallel to the longitudinal axis of the solar tracker that is similar to the outer dimension of the first pile. (For convenience and brevity of description, the direction transverse to the longitudinal axis of the solar tracker will be referred to throughout this specification as the “east-west direction” and the direction parallel to the longitudinal axis of the solar tracker will be referred to as the “north-south direction”. This naming convention does not require or imply that the longitudinal direction of the solar tracker is running north-south in accordance with the compass.) The second support and second pile may be similarly arranged. For example, the lower openings may comprise tubes that are flattened on the north-south faces, or the openings are of generally oval shape or the openings are of rectangular shape and the north-south dimension is smaller than the east-west dimension.

In one embodiment, the first support is hingedly mounted to the first screw pile. In one embodiment, the first support is pivotally mounted to the first screw pile.

In one embodiment, the first support is pivotally mounted to the first pile by a pin or a bolt that extends along a north-south direction. The second support may be similarly mounted to the second pile. In this manner, limited movement or rotation of the first support and the second support in the east-west direction can be achieved. This can provide a degree of dampening during peak wind loads.

In one embodiment, a lower end of a first support has flattened north and south faces and the flattened north and south faces of the lower end have substantially the same dimension as the diameter of the shaft of a pile such that an interference fit is established and the east and west faces of the lower end of the first support have a larger dimension than a diameter of the shaft of the pile, wherein the ends of first support enable east-west movement of the first support relative to the shaft of the pile. The second support may be similarly arranged.

In another embodiment, the lower end of the first support is received within the open upper end of the first pile and the first pile has a larger dimension in the east-west direction than in the north-south direction. The first support may have an outer dimension in the north-south direction that is very close to the inner dimension in the north-south direction of the first pile. This also allows for limited rotational movement to be achieved between the first support and the first pile. The second support and the second pile may be similarly arranged.

In one embodiment of the present invention, the support system for the solar tracker may comprise a motor support, the motor support including three or four piles inserted into the ground and three or four support extending upwardly from the piles, upper ends of the three or four supports adapted to enable a motor drive for the torque tube to be mounted thereto.

In one embodiment, the upper ends of the three or four supports are flattened and, in an installed position, the motor drive for the torque tube is mounted to the flattened ends. In another embodiment, a mounting plate is mounted to the upper ends of the three or four supports.

In one embodiment, a connector is used to connect the upper ends of the three or four supports to each other. The connector may comprise a plate having three or four legs extending downwardly at an angle to vertical, the three of four legs being adapted for insertion into respective upper proportions of the three or four supports. In this embodiment, the legs may be crimped or bolted or affixed by other fasteners to the supports.

In one embodiment, each leg has a lower region that tapers inwardly or each leg has an outer part of a lower region removed therefrom, or the outer part of the lower region having reduced cross-sectional area at an outer region thereof. In this embodiment, insertion of the angled legs of the connector into the top portions of the respective supports is facilitated by the tapering lower region or the lower region that has an outer part removed therefrom.

In one embodiment, the legs have ribs thereon, or the legs have alternating regions of larger diameter or area and smaller diameter or area, with shoulders located therebetween. In these embodiments, affixing of the motor connector to the three or four supports by crimping is enhanced by the ribs or alternating regions of larger diameter and smaller diameter/area.

In one embodiment, the motor support comprises a base portion, three or four sleeves extending downwardly at an angle to vertical, the sleeves extending over a top portion of respective ones of the three or four supports, and fasteners for connecting the sleeves to the piles. The base portion may comprise a base plate. One or more reinforcing gussets or reinforcing plates may also be provided. The sleeves may be provided with aligned openings for receiving fasteners that also pass through openings formed in the top portion of the supports. In one embodiment, the fasteners comprise bolts and nuts. In another embodiment, the fasteners comprise screws. In another embodiment, the fasteners comprise rivets.

In some embodiments of the present invention, rather than having a first support and a second support that are connected at the upper ends by the connector, a single A-frame support or arched support having two legs that connect to the first pile and the second pile may be provided.

Accordingly, in a third aspect, the present invention provides a support for a solar tracker support system, the support including two screw piles or blade piles inserted into the ground, the two screw piles or blade piles being spaced from the longitudinal axis of the solar tracker, and an upper support having a first leg and a second leg and an upper region interconnecting the first leg to the second leg, the first leg mounted to a first pile of the two screw piles or blade piles and extending upwardly therefrom, the second leg mounted to a second pile of the two screw piles or blade piles and extending upwardly therefrom.

In one embodiment, the upper region of the support comprises an arcuate portion or an arched portion.

The upper support may be formed from a unitary piece of material. The upper support may be formed by bending a tube.

In this aspect of the present invention, the support may further include a solar tracker mount connected to the upper region of the support. The solar tracker mount may be similar to the connector used in the first and second aspects of the present invention.

In one embodiment, the lower region of the first leg and the lower region of the second leg extend in a substantially vertical direction. In this embodiment, the lower region of the first leg and the second leg can be easily fitted to the upper regions of the first pile and the second pile. The lower regions of the first leg and the second leg may comprise separate components that are joined to the first leg and the second leg, or the lower regions of the first leg and second leg may be integrally form with the first leg in the second leg. In one embodiment, the lower regions of the first leg and the second leg extend in a substantially vertical direction and are formed by bending or otherwise shaping the lower parts of the first leg and the second leg.

In one embodiment, the support has a lower region of the first leg that is positioned over an upper region of the first pile and the support has a lower region of the second leg that is positioned over an upper region of the second pile. In another embodiment, the support has a lower region of the first leg that is positioned inside an upper region of the first pile and the support has a lower region of the second leg that is positioned inside an upper region of the second pile. The first leg and the second leg may be affixed to the respective first and second piles by use of a bolt or a pin.

In one embodiment of the third aspect of the present invention, the solar tracker mount comprises a solar tracker support, a base portion connected to or formed with the solar tracker support, and two opposed ears or plates extending downwardly from the base portion, a first ear or plate located to one side of the upper region of the upper support, a second ear or plate located to another side of the upper region of the upper support, and fasteners to fasten the first ear and the second ear to the upper region of the upper support. In one embodiment, the fasteners extend through the first ear or plate and the second ear or plate to affix the upper region of the upper support to the first ear or plate and to the second ear or plate. In one embodiment, the fasteners comprise bolts and nuts. In another embodiment, the fasteners comprise screws. In another embodiment, the fasteners comprise rivets. In one embodiment, the first ear or plate and the second ear or plate may be provided with aligned openings for receiving one or more fasteners. The aligned openings may be positioned in alignment with one or more openings formed in the top portions of the first support pile and the second support.

In some embodiments of the third aspect of the present invention, the first leg and the second leg of the upper support may be mounted for limited relative rotation between the first leg and the first pile in a direction transverse to a longitudinal axis of the solar tracker and for limited relative rotation between the second leg and the second pile. This may be achieved in a manner similar to that described in paragraphs [0032] to [0036] of this specification.

In one embodiment of the third aspect of the present invention, a motor mount is mounted to two adjacent supports of the third aspect. The motor mount may include a motor mounting plate having bolt holes for receiving mounting bolts to mount a motor thereto.

In another embodiment of the third aspect of the present invention, a motor mount is mounted to two adjacent supports of the third aspect, each support comprising two screw piles or blade piles inserted into the ground, the two screw piles or blade piles being spaced longitudinally from the longitudinal axis of the solar tracker, and an upper support having a first leg and a second leg and an upper region interconnecting the first leg to the second leg, the first leg mounted to a first pile of the two screw piles or blade piles and extending upwardly therefrom, the second leg mounted to a second pile of the two screw piles or blade piles and extending upwardly therefrom, the first leg extending upwardly and inwardly towards a longitudinal axis of a solar tracker mounted thereto and also extending towards the adjacent support. The motor mount may comprise a bracket having an upper surface for mounting the motor thereto and downwardly extending side surfaces, one side surface extending down over a first leg and a second leg and an opposed side surface extending over an adjacent first leg and an adjacent second leg. The side surfaces may include openings or slots to enable the side surfaces to be connected to the legs, such as by bolting or riveting.

In another aspect, the present invention provides a blade pile comprising a hollow shaft, a first blade mounted near a lower end of the hollow shaft and a second blade mounted at near the lower end of the hollow shaft, the first blade having a plurality of tabs extending through respective openings in a side wall of the hollow shaft, the second blade having a plurality of tabs extending through respective openings in a side wall of the hollow shaft, the first blade and the second blade being affixed to the hollow shaft.

In one embodiment, the first blade has two tabs and the second blade has two tabs.

In one embodiment, the first blade comprises a plate and the second blade comprises a plate. In one embodiment, the first blade and the second blade have a recessed region or cut out region that is complimentary in shape to an outer surface of the hollow shaft, with the plurality of tabs being located in or adjacent to the recessed region or cut out region.

In one embodiment, the hollow shaft comprises a generally cylindrical hollow shaft.

In one embodiment, the first blade and the second blade are welded to the hollow shaft to affix the first blade and the second blade to the hollow shaft.

In one embodiment, the lower end of the hollow shaft is shaped to sweep away rocks and soil as the blade pile is rotatably driven into the ground.

In the completed shaft, the plurality of tabs on the first blade and the second blade extend into the interior volume of the hollow shaft. Accordingly, the tabs stand inwardly proud of the inner surface of the hollow shaft. Therefore, the tabs can provide engagement surfaces for a drive tool which is inserted into the hollow shaft to engage the tabs and to enable the blade pile to be driven into the ground. The drive tool will typically comprise an elongated shaft having a splined lower region, whereby recesses in the splined lower region are of complementary shape to the tabs extending into the hollow shaft so that recesses in the splined lower region of the drive tool engage with the tabs.

In one embodiment, the drive tool has a lower end that is shaped as a bit to enable the drive tool to break rock as it is driven into the ground.

The blade piles of this aspect of the present invention can be used in the solar array support arrangement of other aspects of the present invention.

In another aspect, the pile may comprise a shaft having a through-ring affixed within a shaft of the pile, the through-ring being located at, near or adjacent to two opposed blades or plates, the through-ring having an opening to receive a drive tool and to be engaged by the drive tool.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a schematic diagram of a prior art support structure for a solar tracker;

FIG. 2 shows a plan view of an installed support structure and torque tube for a solar tracker in accordance with an embodiment of the present invention;

FIG. 3 shows an end view of a support in accordance with one embodiment of the present invention;

FIG. 4 shows a side view of the support shown in FIG. 3;

FIG. 5 shows a front view of a connector for use in the support structure shown in FIG. 3, in accordance with an embodiment of the present invention;

FIG. 6 shows a perspective view of another connector for use in the support structure shown in FIG. 3, in accordance with a further embodiment of the present invention;

FIG. 7 shows a front view of the connector shown in FIG. 6;

FIG. 8 shows a schematic diagram of the force being applied to the support structure shown in FIG. 3. In FIG. 8, the blank space between the piles and below ground level is merely an artefact of the drawing process and does not represent any feature;

FIG. 9 shows a schematic view of possible east-west movement in the support structure shown in FIG. 3, for example, during high wind conditions;

FIG. 10 shows a close-up side view of the connection between the pile and the support leg in accordance with an embodiment of the present invention;

FIG. 11 shows a schematic view of support structures in accordance with embodiments of the present invention;

FIG. 12 shows a schematic side view of east-west movement in a support structure in accordance with an embodiment of the present invention;

FIG. 13 shows a cross-sectional top view of the connection between the pile and the support;

FIG. 14 shows a similar view to FIG. 12, but with the movement being in the opposite direction;

FIG. 15 shows an end view of a support structure in accordance with another embodiment of the present invention;

FIG. 16 shows a side view of the support structure shown in FIG. 15;

FIG. 17 shows a side view of a connector suitable for use in the embodiment of FIG. 15;

FIG. 18 shows a side view of a connector suitable for use in the support structure shown in FIG. 19;

FIG. 19 shows an end view of a support structure in accordance with another embodiment of the present invention;

FIG. 20 shows a side view of the support structure shown in FIG. 19;

FIG. 21 shows a side view of a motor mount structure in accordance with an embodiment of the present invention, with two alternative connectors being shown;

FIG. 22 shows a plan view of the motor support structure shown in FIG. 21;

FIG. 23 shows an end view of an embodiment of the present invention in accordance with the third aspect of the invention;

FIG. 24 shows a side view of the embodiment shown in FIG. 23;

FIGS. 25 and 26 show steps involved in assembling a support structure in accordance with another embodiment of the present invention;

FIG. 27 shows a cross-sectional top view of the connection between the pile and the support legs of the embodiment shown in FIGS. 25 and 26;

FIG. 28 shows and end view of a support structure in accordance with another embodiment of the present invention;

FIG. 29 shows a side view of the embodiment shown in FIG. 28;

FIG. 30 shows an end view of a support structure in accordance with another embodiment of the present invention;

FIG. 31 shows an end view of a support structure in accordance with another embodiment of the present invention;

FIG. 32 shows a schematic view of a support structure having motor mounts/connectors fitted thereto;

FIG. 33 shows a plan view of a motor mount support structure in accordance with another embodiment of the present invention;

FIG. 34 is a perspective view demonstrating how a motor to drive a torque tube solar tracker can be mounted to a motor mount;

FIG. 35 shows a perspective signed view, from an east-west perspective, of an alternative motor mount for use in the present invention;

FIG. 36 shows a view, from a north south perspective, of the top of the motor mount shown in FIG. 35;

FIG. 37 shows a front view, from a north-south perspective, of another embodiment of the present invention;

FIG. 38 shows a side view of FIG. 37;

FIG. 39 shows a front view, from a north-south perspective, of another embodiment of the present invention;

FIG. 40 shows a side view of FIG. 39;

FIG. 41 shows a perspective view of alternative motor mount arrangement in accordance with an embodiment of the present invention;

FIG. 42 shows a plan view of a solar tracker array having the motor mount arrangement shown in FIG. 41;

FIG. 43 shows a close-up plan view of the motor mount arrangement shown in FIG. 41

FIG. 44 shows a perspective view of the bent tube that forms the upper part of the motor mount foundation for the motor mount arrangement shown in FIG. 41;

FIG. 45 shows a perspective view of the motor mount bracket use with the motor mount arrangement shown in FIG. 41;

FIG. 46 shows a plan view of the flat sheet of metal from which the bracket shown in FIG. 45 is made;

FIG. 47 shows a plan view of one possible arrangement for cutting out the motor mount bracket shown in FIG. 45 from a larger sheet of steel;

FIG. 48 shows a view of a support in accordance with another embodiment of the present invention;

FIG. 49 shows views of various bent tube shapings that can form the upper part of support structures of embodiments of the present invention;

FIG. 50 shows an alternative motor mount structure in accordance with another embodiment of the present invention;

FIG. 51 shows various views of possible upper parts of support structures in accordance with other embodiments of the present invention;

FIG. 52 shows a view of a protective boot suitable for use in the present invention;

FIG. 53 shows a perspective view of a lower end of a blade pile suitable for use in the present invention, with the shaft of the blade pile shown in shadow so that internal details can be seen;

FIG. 54 shows a perspective view of a shaft that can be used in the blade pile shown in FIG. 53;

FIG. 55 shows a perspective view of a blade that can be attached to the shaft shown in FIG. 54 to form the blade pile shown in FIG. 53;

FIG. 56 shows a perspective view from above of the lower end of the blade pile shown in FIG. 53, with the shaft and one of the blades shown in shadow so that internal details can be seen;

FIG. 57 shows an underneath view of the blade pile shown in FIG. 53,

FIG. 58 shows a perspective view from the side of the lower end of the blade pile shown in FIG. 53;

FIG. 59 shows the blade pile of FIG. 53 having a drive tool inserted therein to enable the blade pile to be driven into the ground. In FIG. 59, the shaft of the blade pile is shown in shadow so that internal details can be seen;

FIG. 60 shows a close-up view of the bottom of the blade pile with the end of the drive tool extending below the bottom of the blade pile;

FIG. 61 shows a view of a drive tool being partly inserted into a blade pile;

FIG. 62 shows a view of another pile and drive tool suitable for use in the present invention; and

FIG. 63 shows a perspective view of the through-ring welded into the pile shown in FIG. 62.

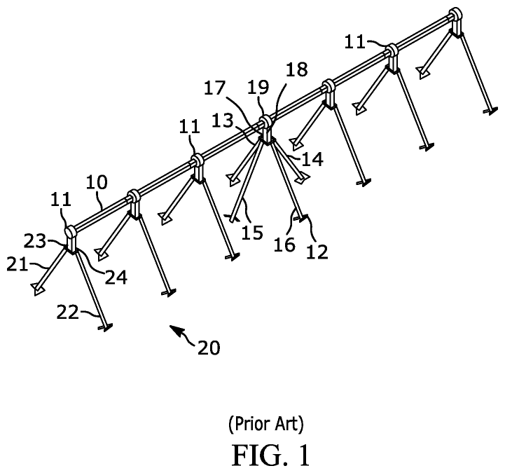

### DESCRIPTION OF EMBODIMENTS

The skilled person will understand that the drawings have been provided for the purposes of describing preferred embodiments of the present invention. Therefore, it will be understood that the present invention should not be considered to be limited to the features as shown in the attached drawings.

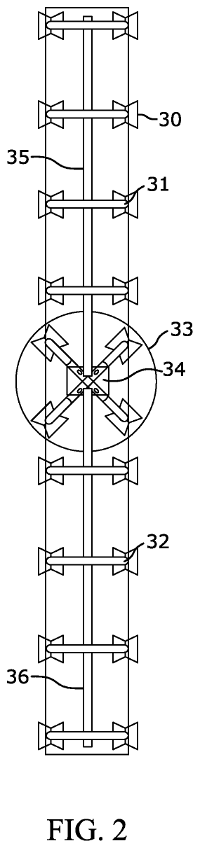

FIG. 2 shows a plan view of an installed solar tracker/solar array utilising a support structure in accordance with embodiments of the present invention. The support structure includes a plurality of aligned and spaced supports, some of which are numbered at 30, 31, 32. A motor support 33 is located towards the centre of the solar array shown in FIG. 20. The motor support 33 supports a motor 34. Torque tubes 35, 36 are connected to the motor and are supported by the aligned and spaced supports. A plurality of solar panels (not shown) amounted to the torque tubes 35, 36 or amounted to rotate with the torque tubes 35, 36. The motor 34 can drive the torque tubes 35, 36 so that the solar panels can be turned to follow the sun as the sun crosses the sky during the day. FIG. 2 shows a support structure that comprises a total of 8 supports and the motor support, although it will be appreciated that the number of supports can vary.

To provide clarity to some of the nomenclature used in this specification, the “north-south direction” of the solar tracker and support structure shown in FIG. 20 corresponds to a direction that is parallel to the longitudinal axis of the torque tubes 35, 36. This does not necessarily require that the torque tubes 35, 36 extend along a north-south direction according to a compass. The “east-west direction” is the direction that extends perpendicularly to the longitudinal axis of the torque tubes 35, 36. Again, this does not imply that the “east-west direction” extends along an east or west line according to a compass. The skilled person will recognise that the solar panels included in the solar array shown in FIG. 2 typically result in force arising from wind load on the solar panels being applied much more strongly in an east-west direction than in a north-south direction. Accordingly, the support structure used to support the torque tube and the solar panels desirably provides greater resistance to force and movement for forces applied in an east-west direction, when compared to a north-south direction.

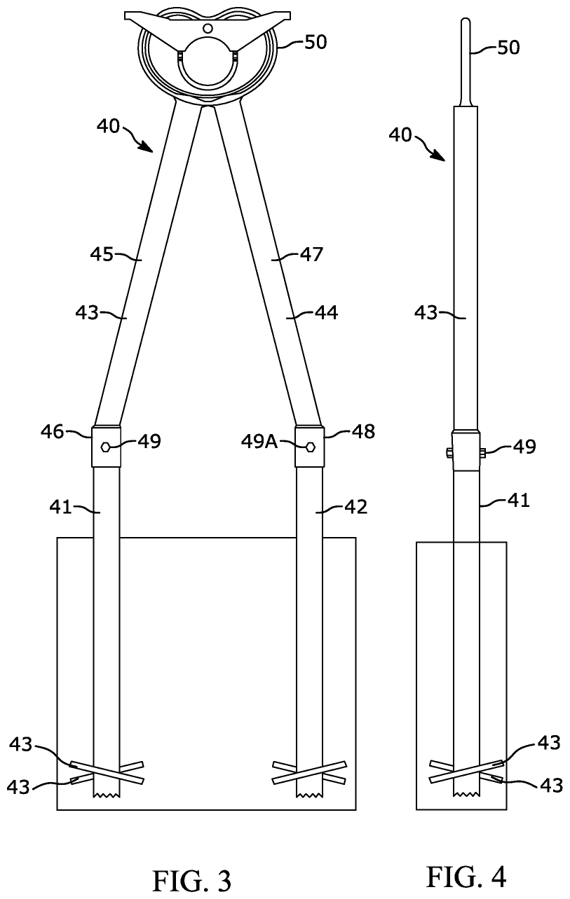

FIGS. 3 and 4 show views of a support structure in accordance with one embodiment of the present invention. The support structure shown in FIGS. 3 and 4 may be used in the solar tracker/solar array shown in FIG. 2, such as support structures 30, 31 and 32 of FIG. 2.

The support structure 40 shown in FIGS. 3 and 4 comprises a first pile 41 and a second pile 42. Piles 41, 42 comprise blade piles and they have respective blades 43 mounted thereto. The blade piles are available from Blade Pile Pty Ltd and may be as described in Australian innovation patent number 2011100820. It will also be understood that conventional screw piles may be used in embodiments of the present invention, if desired, although using blade piles provides several benefits.

Piles 41 and 42 are mounted in the ground in spaced relationship and in a vertical orientation. The first pile 41 has a first support 43 mounted thereto and the second pile 42 has a second support 44 mounted thereto. The first support 43 comprises a support leg 45 and a sleeve 46 of larger diameter welded to the support leg 45. The second support 44 comprises a support leg 47 and a sleeve 48 of larger diameter welded to the support leg 47. As can be seen from FIG. 3, the sleeve 46 extends at a different angle to the leg 45. Similarly, sleeve 48 extends at a different angle to leg 47.

The sleeve 46 is positioned over the top of pile 41 such that the sleeve 46 is essentially parallel to the longitudinal axis of the pile 41 (and such that the sleeve is essentially vertical). In other words, the sleeve 46 extends in a vertical orientation. Due to the angle between the sleeve 46 and the leg 45, the leg 45 extends upwardly and inwardly towards the longitudinal axis of the solar tracker array. Sleeve 48 and leg 47 are similarly located and arranged on second pile 42. Respective bolts 49, 49A are used to affix the supports 43, 44 to their respective piles 41, 42. As will be described hereunder, the connection between the supports 43, 44 and their respective piles 41, 42 allows limited rotation of the supports in the east-west direction.

The assembly is arranged such that the upper ends of legs 45 and 47 are located close to each other. In order to complete the support structure 40, a connector 50 is connected to the upper ends of legs 45 and 47. The connector 50 will be described in more detail hereunder. The connector 50 rigidly connects the upper ends of the legs 45, 47 to each other to form an A-frame support structure.

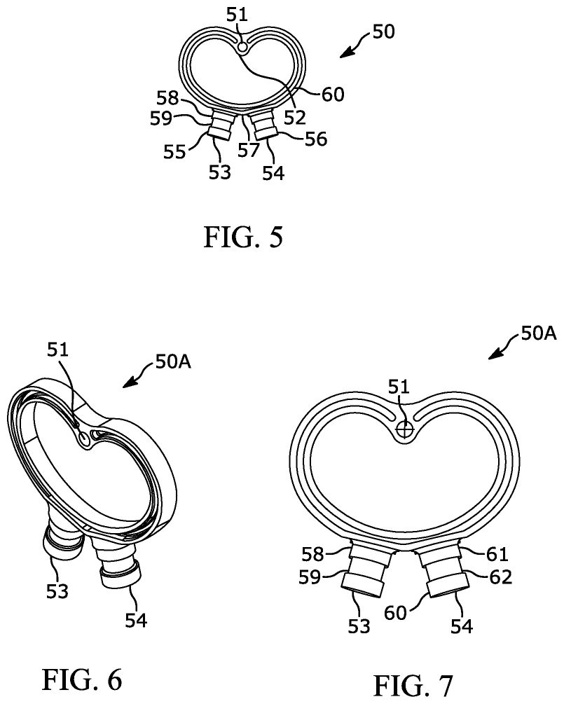

FIG. 5 shows a front view of a connector 50 that can be used in the embodiments shown in FIGS. 3 and 4. The connector 50 comprises a loop of material 60 that has an opening 51 therein to receive a bearing pin of a solar tracker hanger. The opening 51 is formed in a cusp region 52 of the loop of material 60.

The connector 50 has two legs 53, 54. As can be seen from FIG. 5, connector legs 53, 54 extend downwardly and outwardly from the loop of material 60. The connector legs 53, 54 extend at an angle to vertical that is essentially the same as the angle to vertical at which the legs 45, 47 extend. The connector legs 53, 54 are designed to be inserted into the upper open ends of the legs 45, 47 and the piles are then crimped to firmly affix the connector legs 53, 54, and hence the connector 50, to the support legs 45, 47. In order to facilitate fitment of the connector legs 53, 54 to the top of the piles, the lower outer regions 55, 56 are chamfered or bevelled or cut off in order to present a smaller cross-sectional area to the angled upper portions of the support legs 45, 47. Alternatively, the lower part of the connector legs 53, 54, may taper inwardly to facilitate insertion of the lower part of the legs into the angled upper portions of the support legs 45, 47. It will be appreciated that the juncture 57 between the connector legs 53 and 54 basically sets the upper parts of the legs 53, 54 to the distance at which the upper portions of the support legs 45, 47 are spaced from each other once they have been mounted to the piles 41, 42. However, the lower ends of the legs 53, 54 are spaced further apart than the tops of the support legs 45, 47. Therefore, it can be difficult to get the lower ends of the legs 53, 54 into the tops of the support legs when first inserting the connector 50 into the support legs. The chamfered, bevelled, cut off or tapered regions 55, 56 assist in this process. Once the ends of the legs 53, 54 have been inserted into the tops of the support legs 45, 47, the connector 50 can be hit downwardly with a hammer or downwardly pressed to fully fit the legs 53, 54 into the upper portions of the support legs 45, 47. The upper parts of the support legs can then be crimped to affix the connector to the support legs.

As can also be seen from FIG. 5, leg 55 has a series of ribs 58, 59. The ribs 58, 59 may be formed by alternating regions of larger diameter and smaller diameter, with the transition between those regions forming shoulders or ribs. The shoulders or ribs allow the upper portions of the support legs 45, 47 to be crimped to securely connect the upper portion of the support legs 45, 47 to the connector legs 53, 54. Once the upper portion of the support legs 45, 47 have been affixed to the legs 53, 54 of the connector 50, the connector 50 firmly and rigidly connects the upper portion of support leg 45 to the upper portion of support leg 47.

The connector 50 may be in the form of an NXT BHA hoop, which is used to support torque tubes in Nextracker solar arrays. The loop of material 60 may be formed from forged steel to provide maximum strength with minimum cross-sectional area of material.

FIGS. 6 and 7 show an alternative connector 50A. Connector 50A is very similar to the connector 50 shown in FIG. 5 and for brevity of description, like features will be denoted by like reference numerals. These features may not be described further. The difference between the connector 50A of FIGS. 6 and 7 and the connector 50 of FIG. 5 is that the connector legs 53, 54 of connector 50A do not have the chamfered, bevelled, cut off or tapered lower portions. The connector 50A can be fitted to the tops of the support legs 45, 47 by flexing the tops of the support legs 45, 47 sufficiently to enable insertion of the legs 53, 54 therein. The regions of larger diameter 60, 61 and the alternating region of smaller diameter 62 of leg 54 are also clearly shown in FIG. 7.

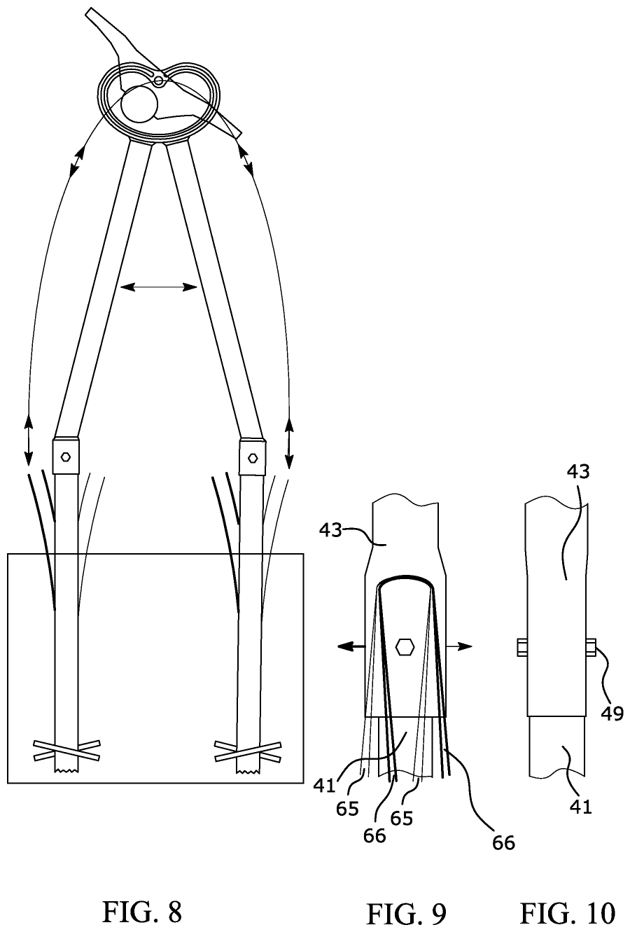

The support structures 40 have the lower ends of the supports 43, 44 joined by an interconnection to the top of the piles 41, 42, providing hinges to release or reduce induced moment loads, whilst maintaining strength, capacity and tracker system tolerances for east-west, north-south, uplift, horizontal and mechanical loads. Some of these loads are shown schematically by the arrows in FIG. 8.

As shown in FIGS. 9 and 10, the pinned connection between the first support 43 and the first pile 41, coupled with the particular shape of the bottom of the first support (to be described below) allow for relative pivoting movement in an east-west direction, which is typically the direction in which maximum wind loads are applied to the support structure, whilst minimising or avoiding movement in a north-south direction. The pinned connection is formed by use of a pin 49 or a bolt 49. Relative movement in an east-west direction allows the top of the pile to move to the locations shown by reference numerals 65 and 66.

FIG. 10 shows the use of a bolt 49 to connect the lower end of the first support 43 to the upper end of the first pile 41. The bolt 49 may be provided with nuts at one or both ends, or, more typically, a head at one end and a nut at the other, in order to enable the bolt to be tightened to the desired degree.

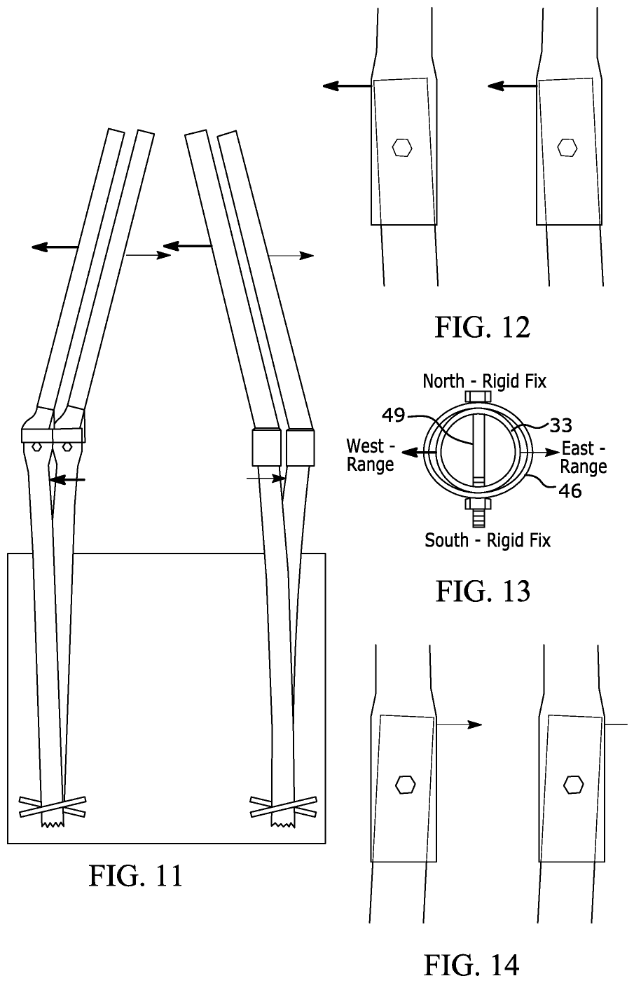

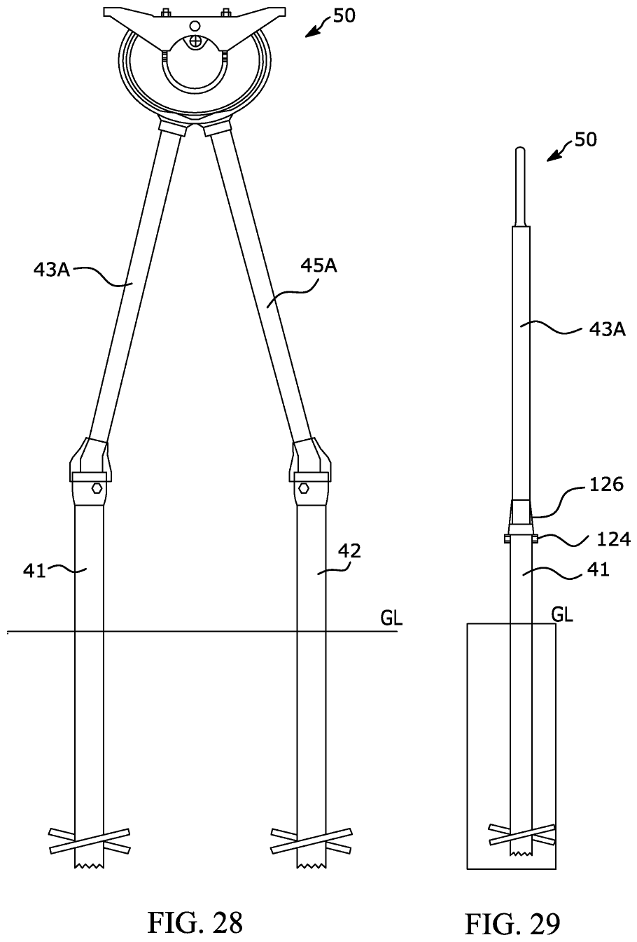

FIG. 13 shows a cross-sectional top view of the shaft 33 of blade pile 41, the lower region 46 of the first support 43 and the bolt 49 that is used to form the pinned connection between the top of the pile 41 and the lower part of the first support 43. As can be seen from FIG. 13, the shaft 33 of the blade pile has a circular cross-section having an outer diameter. In contrast, the lower region 46 of the first support 43 is flattened in the north-south direction and elongated in the east-west direction. This may be achieved by forming the lower section as an oval or, more conveniently, by forming the lower section from a circular hollow section steel sleeve and flattening the lower region in the north-south direction which will elongate it in the east-west direction. Due to the particular shaping of the pile shaft 33 and the lower region 46 of the first support 43, gaps between the two components are formed in the east-west direction, thereby allowing relative movement between the two components in the east-west direction. In contrast, there is no gap formed between the two components in the north-south direction, resulting in a rigid fit between the two components in the north-south direction. The range of possible movement in the east-west direction is shown schematically in FIGS. 11, 12 and 14. It is noted that the right-hand side of FIG. 11 shows possible movement in the embodiment shown in FIGS. 3 and 4 whilst the left-hand side of FIG. 11 shows possible movement in the embodiment shown in FIG. 28.

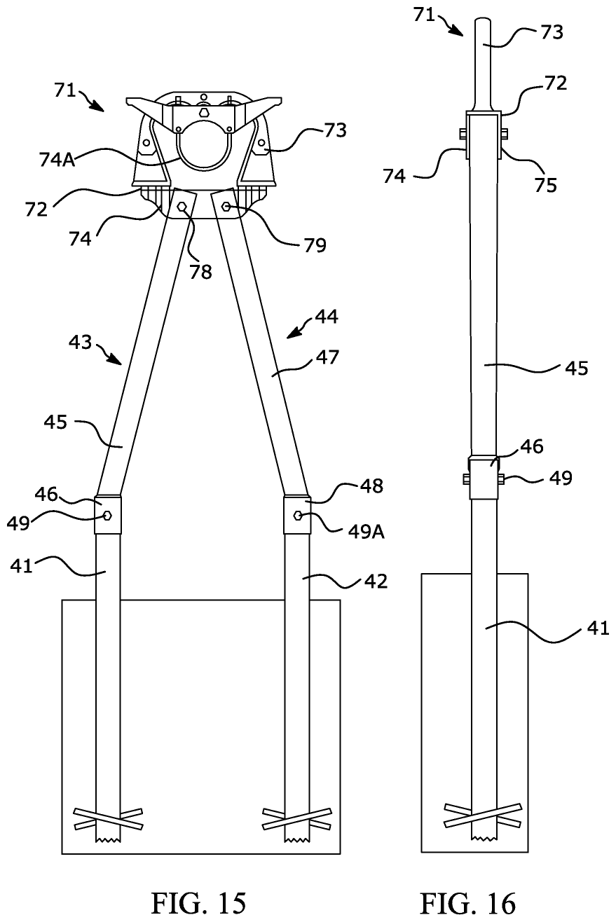

FIGS. 15, 16 and 17 show various views of another embodiment in accordance with the present invention. In FIGS. 15 and 16, a support 70 for a solar tracker array comprises two piles 41, 42 inserted into the ground in a vertical orientation, in the same manner as described with reference to FIG. 3. The piles 41, 42 may be identical to the piles 41, 42 as shown in FIG. 3 and need not be described further. They are inserted into the ground in the same manner as described with reference to FIG. 3. Supports 43, 44 are then mounted to the piles 41, 42 in the same manner as described with reference to FIG. 3. For convenience and brevity of description, like reference numerals will be used to describe like components and these components need not be described further.

A connector 71 comprises a base plate 72 having a generally U-shaped loop 73 welded there too. The loop 73 carries a hanger 74A for a solar array torque tube, in a similar manner to that as described with reference to FIGS. 3 and 4. Opposed ears 74, 75 extend downwardly from the base plate 72. These are best shown in FIG. 16. The ears 74, 75 are opposed to each other and spaced from each other by distance equal to or just slightly greater than the diameter of the tubes that form the support legs 45, 47.

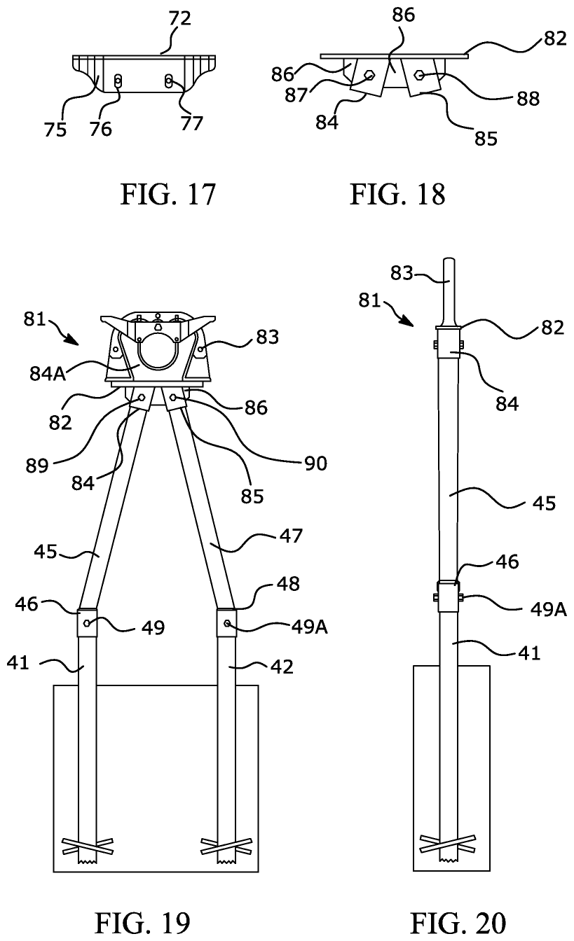

In order to fit the connector 71 to the upper portion of the support legs 45, 47, once the piles have been installed in the ground and the supports 43, 44 connected thereto, the connector 71 is positioned such that the opposed ears 74, 75 are positioned on either side of the upper parts of the support legs 45, 47, as shown in FIG. 16. As shown in FIG. 17, ear 75 has apertures 76, 77 formed therein and opposed ear 74 (not shown) has similar apertures that are aligned with apertures 76, 77. Similarly, the upper portion of the support legs 45, 47 also have apertures formed therein, such as by drilling. The connector 71 is positioned such that the apertures 76, 77 in ear 75 and the aligned apertures in ear 74 come into alignment with the apertures in the upper portion of the piles 41, 42. Nuts and bolts 78, 79 are inserted through the aligned apertures and tightened to securely affix the connector 71 to the upper portion of the piles 41, 42. This forms an A-frame support structure that is firmly held in the ground.

FIGS. 18, 19 and 20 show various views of another embodiment in accordance with the present invention. In FIGS. 19 and 20, a support 80 for a solar tracker array comprises two piles 41, 42 inserted vertically into the ground, in the same manner as described with reference to FIG. 3. The piles 41, 42 may be identical to the piles 41, 42 is shown in FIG. 3 and need not be described further. They are inserted into the ground in the same manner as described with reference to FIG. 3. Supports 43, 44 are then mounted to the piles 41, 42 in the same manner as described with reference to FIG. 3. For convenience and brevity of description, like reference numerals will be used to describe like components and these components need not be described further.

A connector 81 comprises a base plate 82 having a generally U-shaped loop 83 welded thereto. The loop 83 carries a hanger 84A for a solar array torque tube, in a similar manner to that as described with reference to FIGS. 3 and 4. Sleeves 84, 85 are welded to the underside of base plate 82. Sleeves 84, 85 are angled at substantially the same angle as the support legs 45, 47. The sleeves 84, 85 have an inner diameter that is substantially the same as or slightly larger than the outer diameter of the support legs 45, 47. Gussets 86 are welded to the base plate and the sleeves 84, 85 to strengthen that part of the connector 81. Apertures 87, 88 are formed through sleeves 84, 85.

Once the piles 41, 42 have been inserted into the ground, the connector 81 is positioned so that the sleeves 84, 85 are fitted over the upper portions of the piles 41, 42. The apertures 87, 88 in the sleeves are brought into alignment with apertures formed in the upper portion of the piles 41, 42 and bolts and nuts 89 are used to affix the sleeves 84, 85 to the upper portions of the piles 41, 42. This provides an A-frame support.

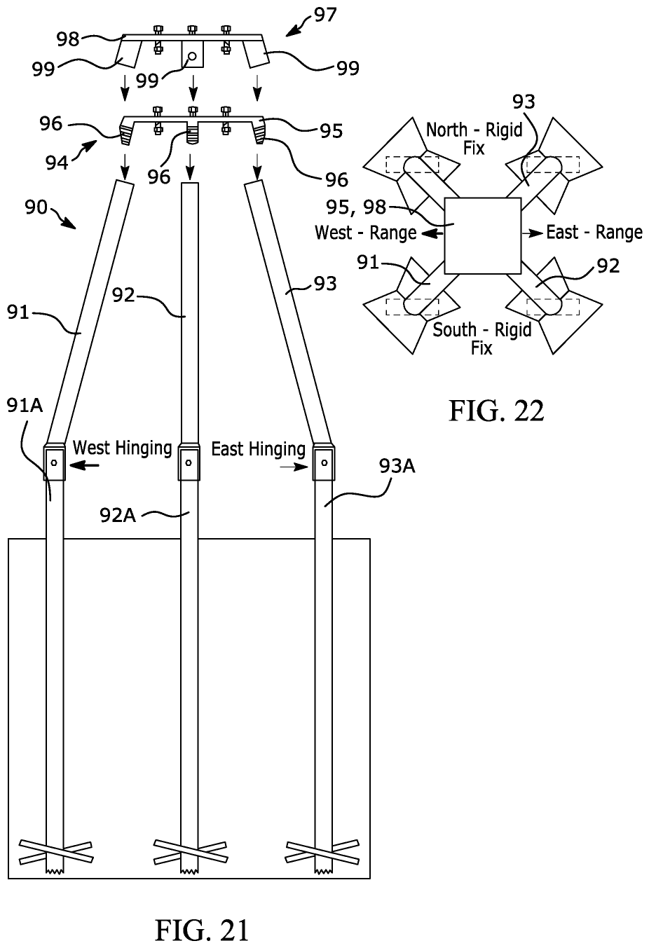

FIG. 21 shows a side view of a support frame for mounting the motor used to drive the solar array to follow the sun. The support frame 90 shown in FIG. 21 comprises 4 support legs, three of which are shown at 91, 92 and 93, with the fourth support leg being hidden behind leg 92. Support legs 91, 92 and 93 are fixed to respective piles 91A, 92A, 93A in a manner as described with reference to FIG. 3. In order to mount the motor to the supports, a motor mount is connected to the top of the pile support legs.

FIG. 21 shows two different types of motor mount that can be used to form the support frame 90. The first motor mount 94 has a base plate 95 and downwardly depending legs 96 that are similar to the legs 52, 53 shown in the embodiment of FIG. 5. Connecting the motor mount 94 to the supports takes place by similar steps to connecting the connector 50 of FIG. 5 to the piles 41 and 42 of FIG. 3.

Alternatively, motor mount 97 has a base plate 98 and downwardly depending sleeves 99 that are similar to the sleeves 84, 85 of the connector 81 shown in FIG. 10. Again, connecting the sleeves 99 to the top of the support legs 91, 92, 93 is effectively the same as connecting the sleeves 84, 85 to the support legs 45, 47 as shown with reference to FIG. 19.

The base plates 95, 98 may provide a four-point slotted bolthole mounting plate, as shown in FIG. 34, to enable the motor 100 to be bolted thereto. FIG. 34 also shows the various nuts, bolts and washers that may be used to bolt the motor 100 to the base plates 95, 98. It will be appreciated from FIG. 34 of the base plates 95, 98 may comprise a plurality of plates connected to each other via one or more intermediate members.

The four A-frame leg structure shown in FIG. 22 with motor mount attached thereto provide a four point slotted bolt hole mounting plate for highly adjustable positioning of the motor. The lower part of the A-frame leg tubes that are used for the motor mount are profiled for a 45° bolthole offset, to ensure that the dampening hinge pin design is correctly maintained for moment loads. As shown in FIG. 22, this allows for limited movement of the motor support structure 90 in the east-west direction.

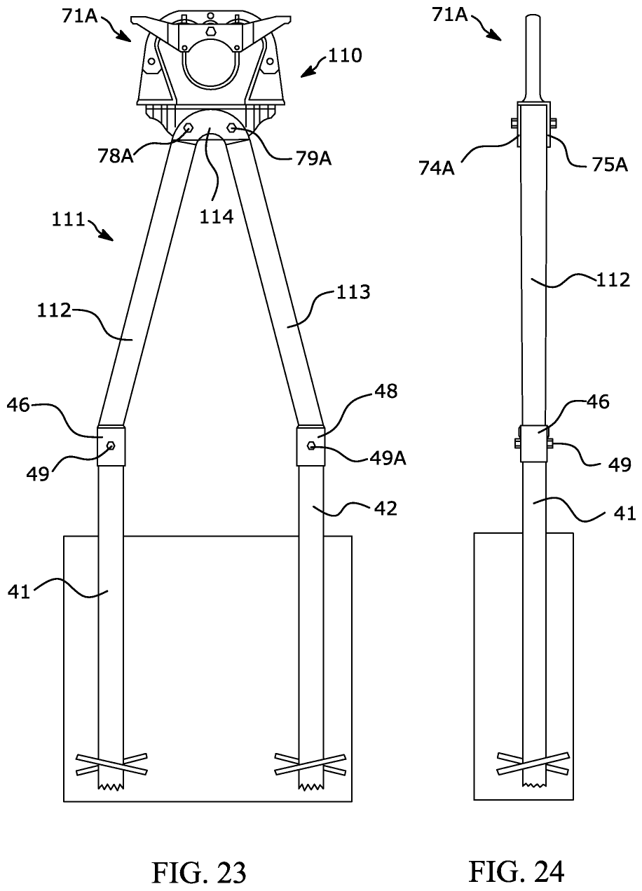

FIGS. 23 and 24 show end and side views, respectively, of a support structure in accordance with another embodiment of the present invention. The support structure 110 comprises a first blade pile 41 and a second blade pile 42 that have been screwed into the ground in a vertical orientation. The support structure 110 further includes a unitary A-frame 111 having a first leg 112 and a second leg 113, with the legs 112, 113 being interconnected by an arcuate or arched region 114. Sleeves 46, 48, which are essential identical to sleeves 46, 48 as described with reference to FIG. 3, are welded to the lower ends of legs 112, 113. As can be seen from FIG. 23, the sleeves 46, 48 are oriented vertically and they are at an angle to their associated legs 112, 113.

In order to assemble the support structure 110, the piles 41, 42 are screwed into the ground in a vertical orientation and the unitary A-frame is positioned on the piles by placing the sleeves 46, 48 over and on top of the upper part of the piles 41, 42. Bolts 49, 49A are then used hingedly connect the legs 112, 113 to their respective piles 41, 42.

In order to enable a solar tracker or a torque tube to be supported by the support structure 110, a connector 71A, which is essentially identical to connector 71 shown in FIGS. 15, 16 and 17, is positioned so that ears 74A, 75A extend on either side of the arcuate or arched region 114. Bolts 78A and 79A then pass through aligned apertures in the ears and through aligned apertures formed in the arcuate or arched region 114 to affix the connector to the arched region 114.

The unitary A-frame 111 may be formed by bending a circular tube to the desired shape. This is likely to cause work hardening in the arched region 114, which improves the strength of the unitary A-frame 111. The connector 70A may be formed in the form of a folded steel plate having slotted holes for added vertical adjustment relative to the support structure. The legs 112, 113 have oversized sleeves welded thereto, with the sleeves having hinging bolt holes therein. As with other embodiments of this invention, the connection between the unitary A-frame 111 and the piles may allow limited rotational movement in the east-west direction.

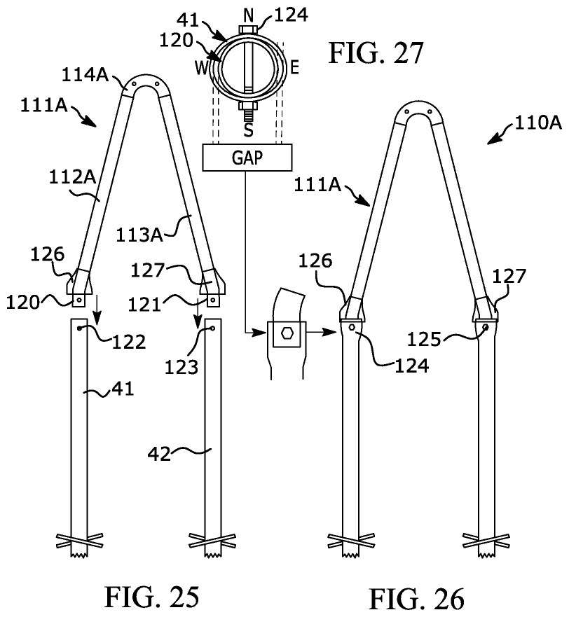

FIGS. 25 to 33 show other embodiments of the support structure in accordance with the present invention. Unlike previous embodiments, the embodiments shown in FIGS. 25 to 33 have the upper legs of the support structures being inserted into open tops of the piles. In contrast, previous embodiments had the open lower ends of the support legs being positioned over and around the upper ends of the piles. In short, the embodiments shown in FIGS. 3 to 24 had the tops of the piles inserted into the open lower ends of the support legs, whereas the embodiment shown in FIGS. 25 to 33 have the lower ends of the support legs inserted into the open upper ends of the piles.

FIGS. 25, 26 and 27 show how an embodiment that is similar to the embodiment shown in FIGS. 23 and 24 can be assembled when the support legs fit inside the open upper ends of the piles. In FIG. 25, piles 41, 42 are inserted into the ground. A unitary A-frame 111A having angled legs 112A, 113A and an arcuate or arched region 114, has lower regions 120, 121 arranged so that lower regions 120, 121 are positioned essentially vertically when in the assembled position. The unitary A-frame 111A is positioned so that the lower regions 120, 121 are located directly above the open upper ends of the piles 41, 42, as shown in FIG. 25. The unitary A-frame 111A is then moved downwardly until apertures in the lower regions 120, 121 come into alignment with apertures 122, 123 in the upper regions of the piles 41, 42. Bolts 124, 125 are then inserted through the respective apertures and bolted to form the joint shown in top view in FIG. 27. The assembled support structure 110A is shown in FIG. 26. Protective rubber boots or plastic boots 126, 127 are slid down to cover the joint between the tops of the piles and the lower regions of the unitary A-frame 111A. The protective rubber boots keep dirt and water from entering into the joint between the piles and the unitary A-frame.

FIG. 27 shows a cross-sectional plan view of the joint between the pile 41 and the lower end 120 of the unitary A-frame 111. As can be seen, the top of the pile 41 has been flattened in the north-south direction to increase its dimension in the east-west direction, which then provides gaps in the east-west direction between the outer wall of the lower end 120 of the unitary A-frame 111A and the inner wall of the pile 41. This allows limited rotation in the east-west direction. As can also be seen from FIG. 27, there is a close fit between the outer wall of the lower end 120 of the unitary A-frame 111A and the inner wall of the pile 41 in the north-south direction, thereby preventing relative rotational movement in the north-south direction.

FIGS. 28 and 29 show a similar embodiment to that shown in FIGS. 25 and 26, except that FIGS. 28 and 29 do not utilise a unitary A-frame, but rather utilise support legs 43A and 45A that are connected together at the top end by a connector 50. The embodiment shown in FIGS. 28 and 29 is similar to the embodiment shown in FIGS. 3 and 4, except that the lower ends of the legs 43A and 43B fit into the open upper ends of the piles 41 and 42. It will also be noted from FIG. 28 that the lower region of the support leg 43A has been bent to be essentially vertical in the installed position and to extend at an angle to the main part of support leg 43A. Support leg 45A is similarly arranged.

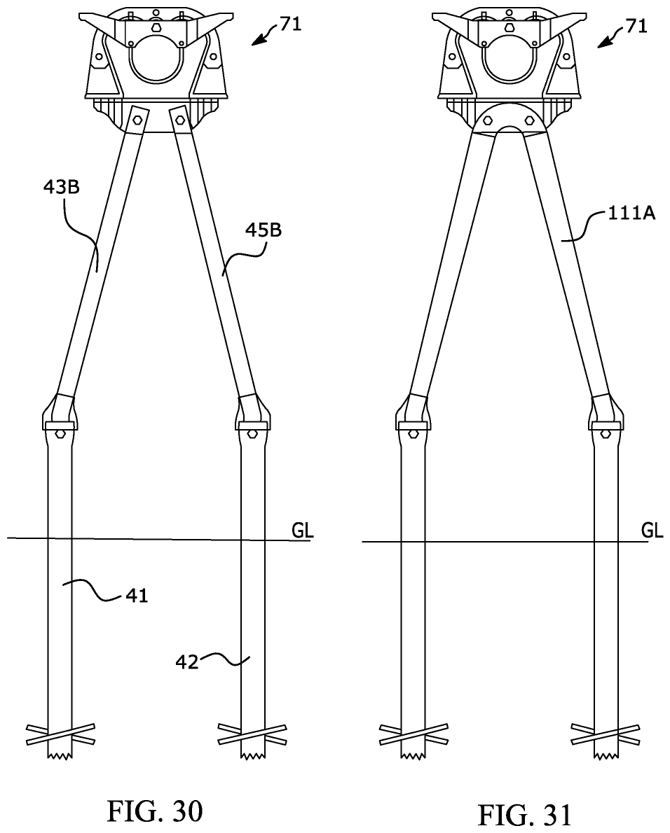

FIG. 30 shows a support structure in which the support legs 43B, 45B are inserted into the open upper ends of the piles 41, 42 and a connector 71 is used to connect the tops of the support legs 43B, 45B together. This is similar to the embodiment shown in FIGS. 15 and 16, except that the lower ends of the support legs are inserted into the open upper ends of the piles.

FIG. 31 is showing the fully assembled support structure of FIGS. 25 and 26, with a connector 71A connected thereto. Again, the embodiment of FIG. 31 corresponds to the embodiment of FIGS. 23 and 24, except that in the embodiment of FIG. 31, the lower ends of the support legs are inserted into the open upper ends of the piles.

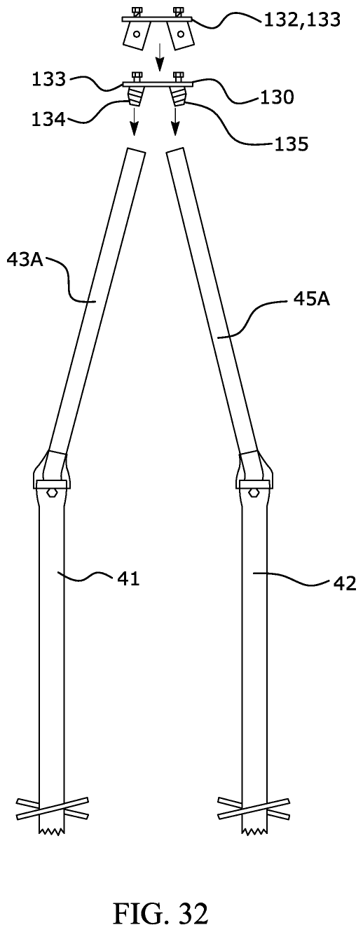

FIG. 32 shows a side view of a motor mount utilising a similar arrangement of piles 41, 42 and support legs 43A, 45A, as shown in FIG. 28, but with the connector 50 of FIG. 28 being replaced by motor mount 130 or motor mount 132. Motor mount 130 is similar to motor mount 94 shown in FIG. 21, whereas motor mount 132 is similar to motor mount 97 shown in FIG. 21.

Motor mount 130 includes a plate 133 having connector legs 134, 135 extending downwardly therefrom. Legs 134, 135 are similar to legs 96 in motor mounting plate 94 of FIG. 21. Motor mount 132 has a plate 136 having sleeves 137, 138 welded to an underside thereof. Sleeves 137, 138 are similar to sleeves 99 shown in FIG. 21. Connection of the motor mounts 130, 132 to the upper parts of the support legs is basically the same as connection of the motor mounts 94, 97 to the upper parts of the support legs and as described with reference to FIG. 21.

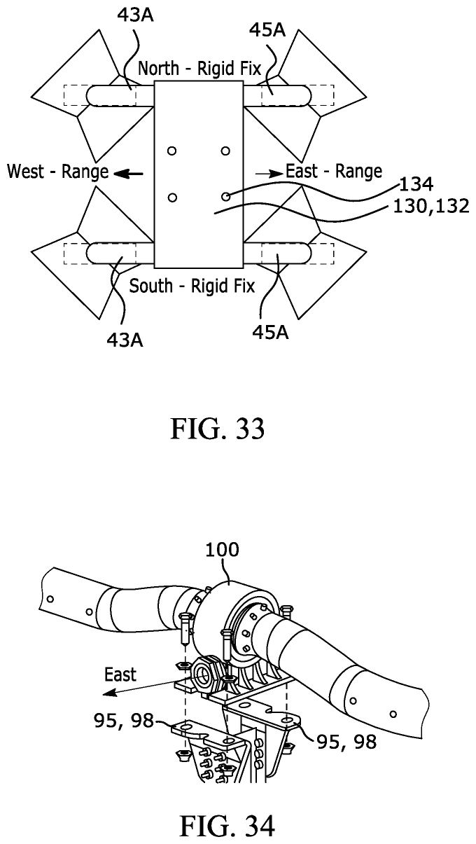

FIG. 33 shows a plan view of the motor support structure. The support structure shown in FIG. 33 includes a first support structure that includes support legs 43A, 45A and a second support structure that includes support legs 43B, 45B. The motor mount 130 132 is mounted to the legs 43A, 45A and 43B, 45B. The motor mount 130, 132 includes a number of bolt holes, one of which is numbered at 134, to enable a motor to be bolted thereto. In an alternative embodiment, two separate motor mounts may be connected to legs 43A, 45A and legs 43B, 45B, and a bridging plate that includes bolt holes 134 may be connected to the two separate motor mounts.

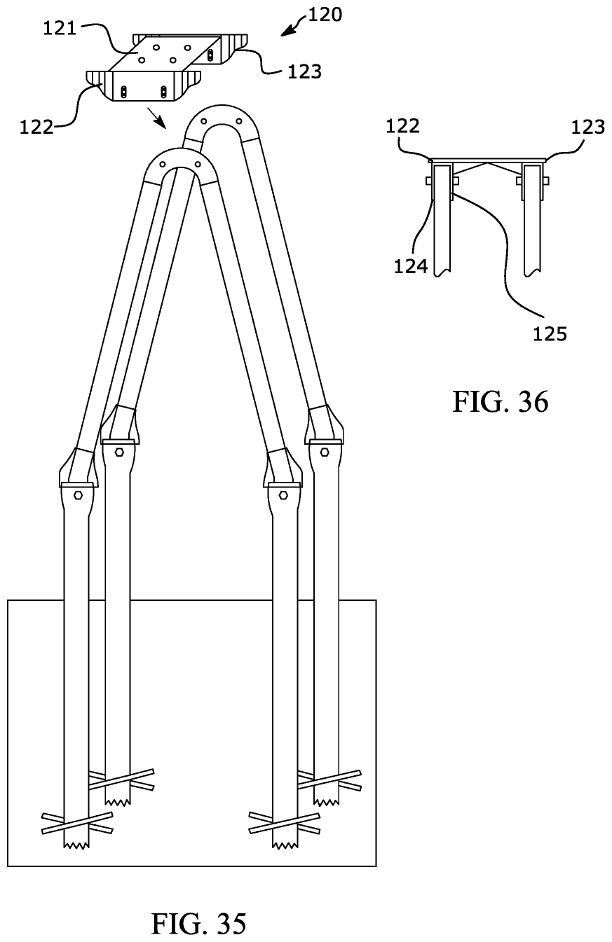

FIGS. 35 and 36 show an alternative motor mount for use in the present invention. The motor mount shown in FIGS. 35 and 36 uses to support structures as shown in FIGS. 25 and 26. These support structures have the arched top and are installed into the ground in exactly the same manner as described with reference to FIGS. 25 and 26, with the support structures are being arranged in the same manner as shown in FIG. 33. The support structures need not be described further.

A connector 120 having a motor mount plate 121 is used to connect the two adjacent support structures to each other and to thereby support the motor mount plate. The connector 120 has a first bracket 122 located at one side of the motor mount plate 121 and a second bracket 123 located at the other side of the motor mount plate 121. Bracket 122 is formed by a first ear 124 and a spaced second ear 125, both ears extending downwardly from the motor bracket. This is shown in FIG. 36. Second bracket 123 is similarly arranged.

In order to mount the connector 120 to the tops of the respective support structures shown in FIG. 35, the ears of bracket 122 are placed on either side of the top part of one of the support structures and the ears of bracket 123 are placed on either side of the top part of the other support structure, as shown in FIG. 36. Bolts are then inserted through respective apertures in the brackets and the tops of the support structures and used to bolt the connector 120 to the support structures. The motor can then be mounted to the motor mount plate 121 of the connector 120.

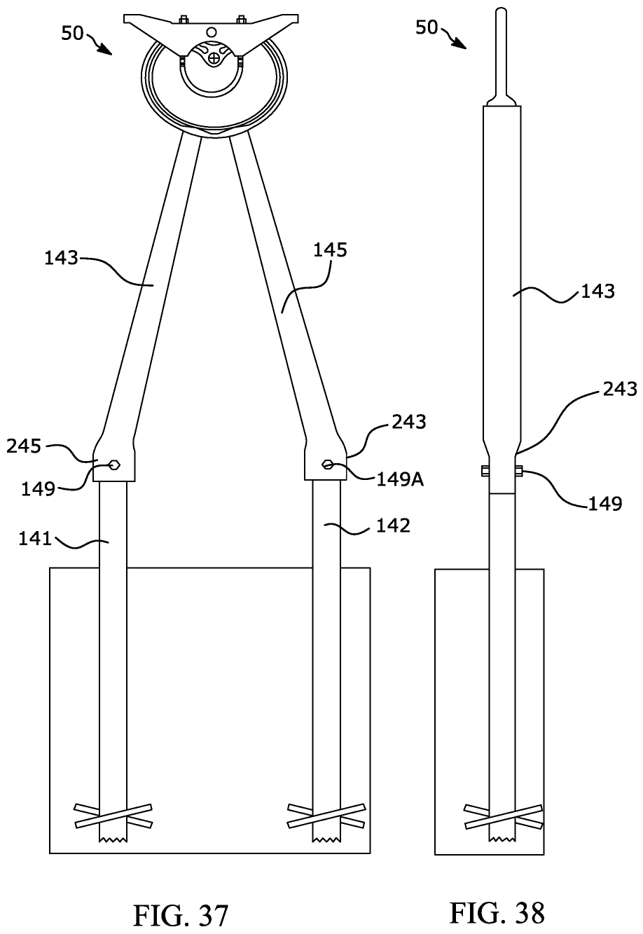

FIGS. 37 and 38 show various views of an alternative embodiment of the present invention. The embodiment shown in FIGS. 37 and 38 is essentially the same as the embodiment shown in FIGS. 3 and 4, except that the sleeves 46, 48 that are welded to the bottom of the legs on the support structure of FIGS. 3 and 4 are not required. In the embodiment of FIGS. 37 and 38, the tubes that are used to form the legs 143, 145, may comprise a larger diameter tube having large strength and, as a result, being able to have thinner sidewalls. Therefore, instead of having to weld on sleeves 46, 48, as in the embodiment shown in FIGS. 23 and 24, the lower ends 243, 245 of the tubes forming the legs 143, 145 are sufficiently large to fit over the tops of the piles 141, 142. The lower ends 243, 245 of the tubes may be flattened in the east-west direction to allow for limited rotation, as described with reference to FIGS. 8 to 14. Bolts 149, 149A pass through respective apertures in the tubes and the piles, in a manner similar to that as described with reference to FIGS. 3 and 4. A connector 50 connects the tops of the legs 143, 145 together, although it will be appreciated than any other connector suitable for connecting two legs together as described in this specification also be used.

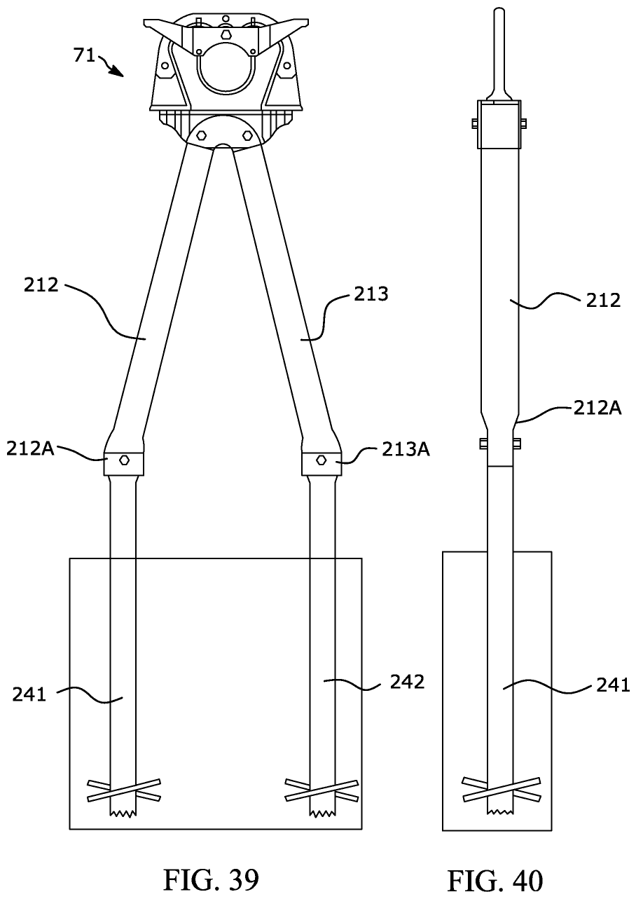

FIGS. 39 and 40 show another embodiment of the present invention and is generally similar to that as shown in FIGS. 23 and 24, except that the sleeves 46, 48 welded to the lower ends of legs 112, 113 of the embodiment of FIGS. 23 and 24 are omitted, because the tubes used to form the legs 212, 213 in the embodiment shown in FIGS. 39 and 40 are of larger diameter and thinner a wall section, meaning that the lower ends 212A, 213A of the legs can fit over the top of the piles 241, 242. Again, the lower ends 212A, 213A can be flattened in the east-west direction to allow for limited rotation.

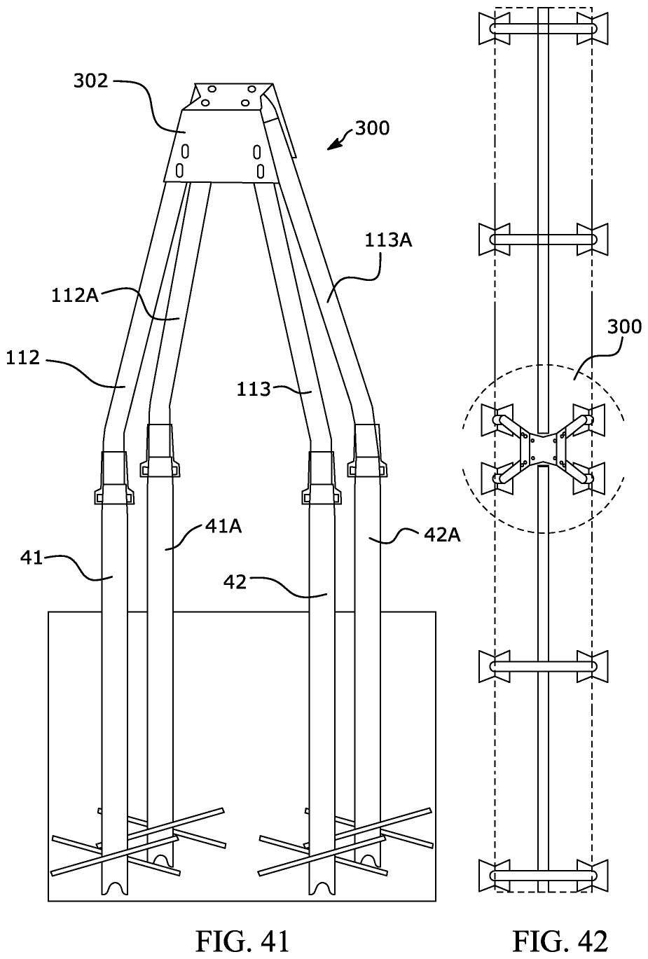

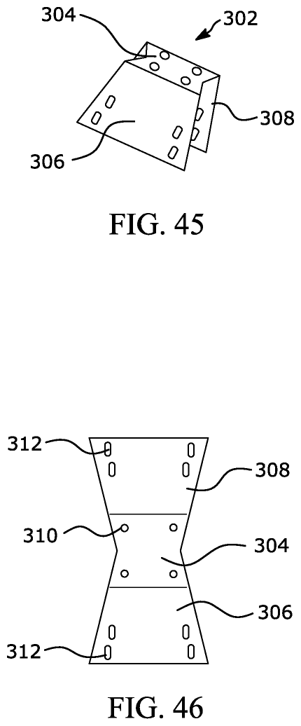

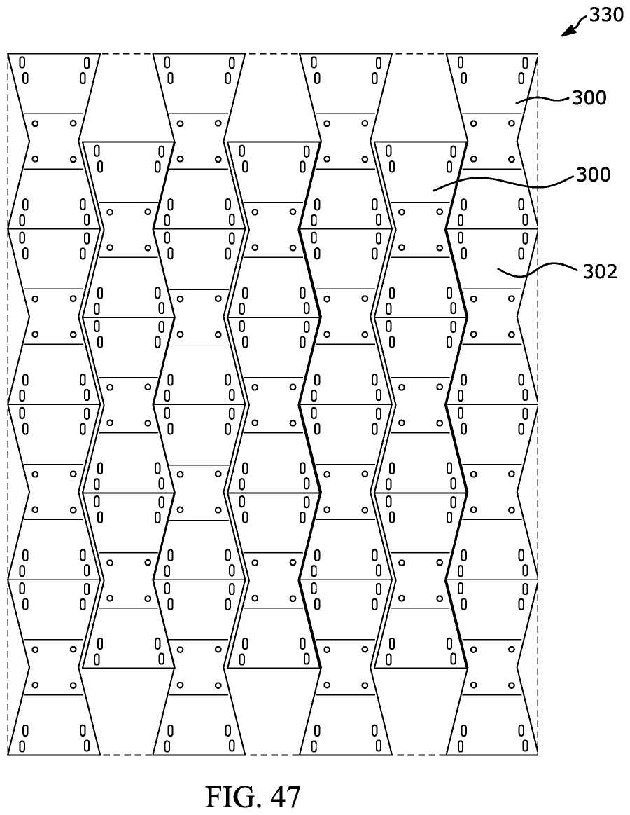

FIGS. 41 to 43 show various views of an alternative motor mount arrangement in accordance with one embodiment of the present invention. FIG. 44 shows a perspective view of the bent tube that forms the upper part of one support for the motor mount arrangement shown in FIGS. 41 to 43. FIGS. 45 and 46 show views of the motor mount bracket and FIG. 47 shows how a number of the motor mount brackets can be cut from a single sheet of steel with minimal wastage.

The motor mount arrangement shown in FIGS. 41 to 43 uses a support that is similar to the support shown in FIGS. 23 to 26. For convenience, similar features will be denoted by similar reference numerals.

The motor mount support arrangement 300 shown in FIGS. 41 to 43 comprises a first support and a second support. The first support has blade pile 41 and blade pile 42 inserted vertically into the ground. An upper support having a first leg 112 and a second leg 113 is mounted into the open upper ends of respective blade piles 41, 42. This arrangement is similar to that shown in FIGS. 23 to 26 and it allows some east-west rotation but is locked in north-south movement. An adjacent second support has blade piles 41A, 42A mounted vertically in the ground. An upper support having a first leg 112A and a second leg 113A is mounted into the open upper ends of respective blade piles 41A, 42A.

As shown in FIG. 44, the first upper support has lower regions 120, 121 that extended generally vertically. First leg 112 extends upwardly and inwardly towards the centreline of the solar tracking array. First leg 112 also extends at an angle towards the adjacent support. Second leg 113 is similarly arranged. Arched region 114 interconnects the first leg 112 and the second leg 113. The first upper support shown in FIG. 44 is suitably made by bending a tube to the desired shape so that the upper support is unitary. The second upper support is essentially identical.

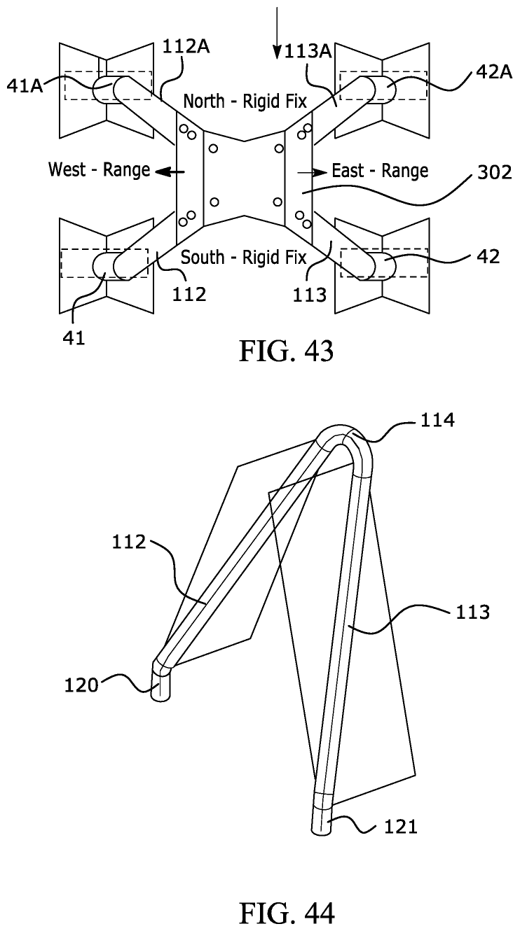

As shown in FIGS. 42 and 43, the first upper support angles towards the adjacent second upper support, and the second upper support angles towards the adjacent first upper support. In this manner, the upper regions 114, 114A of the first and second upper supports are located close to each other. A motor mounting bracket 302 is then connected to the upper legs of the first upper support and the second upper support and the motor mounting bracket 302 bridges the upper regions 114, 114A of the adjacent supports.

The motor mounting bracket 302 is shown in FIG. 45. The motor mounting bracket 302 includes a flat upper surface 304 having openings 310 formed therein, such as by drilling or laser cutting. Openings 310 can receive bolts that enable the motor to be bolted to the flat upper surface 304. The motor mounting bracket also includes a first side surface 306 and a second side surface 308. Side surfaces 306, 308 extend downwardly and outwardly but also splay outwardly. Effectively, the side surfaces of the motor mounting bracket follow the angle of the first and second legs of the first and second upper supports. Side surfaces 306, 308 include slots 312 formed therein to allow the side surfaces to be connected to the upper parts of the first and second upper supports. Bolts may be used to connect the side surfaces of the motor mounting bracket 302 to the upper parts of the upper supports.

As can be seen from FIGS. 46 and 47, the motor mounting bracket 302 can be formed from a flat sheet of metal by cutting to the appropriate shape and bending down the side surfaces 306, 308. As shown in FIG. 47, each flat sheet that is used to fabricate each motor mounting bracket 302 can be cut from a large sheet 330 of steel. Due to the shape of the motor mounting bracket, only minimal wastage of steel occurs.

It will be appreciated that the motor mounting bracket could be formed from other materials and manufacture two different processes, such as forging, casting, stamping, or even moulding from heavy duty synthetic materials or heavy-duty polymers. Other processes or materials may improve the shape of the mounting plate, for different methods of bracing and strengthening, for improved connection and for improved performance to the supporting members or foundation members.

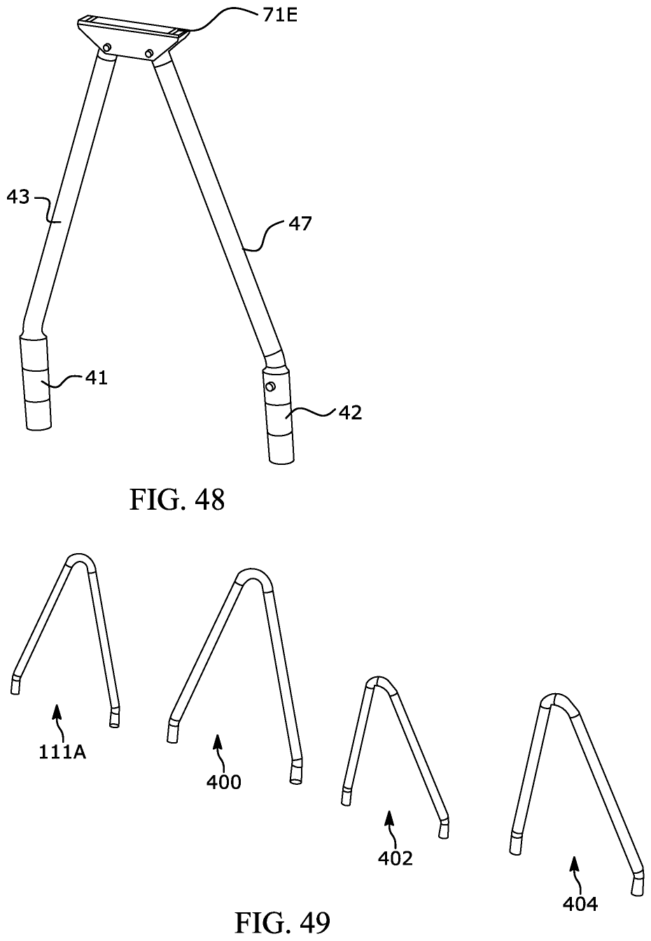

FIG. 48 shows a view of an upper part of the support structure in accordance with another embodiment of the present invention. The support structure of FIG. 48 is generally similar to that shown in FIGS. 23 and 24 and, for convenience, like features will be denoted by like reference numerals from FIGS. 23 and 24. The embodiment of FIG. 48 differs in that the connector 71B does not have the solar tube hanger formed therewith. Rather, the connector 71B has a flat upper surface 71C and mounting slots 71D and 71E to which a solar tube hanger can be connected, such as by bolts or screws. In FIG. 48, only the upper ends of piles 41, 42 have been shown.

FIG. 49 shows views of a number of different upper structures can be used in the present invention. Upper structure 111A shown in FIG. 49 is similar to the upper structure 111A shown in FIG. 31. Upper structure 400 shown in FIG. 49 is essentially a taller version of upper structure 111A. Upper structure 402 has the top of the U-bend offset from centre. Upper structure 404 is a taller version of upper structure 402. It will be appreciated that the dimensions and the specific shape of the upper structures may vary in accordance with the requirements of any particular solar array design.

FIG. 50 shows a motor mount arrangement that is similar to that shown in FIG. 41. In FIG. 50, the support structure comprising piles and tubes is essentially identical to that shown in FIG. 41 and need not be described further. However, in FIG. 50, the motor mount 302 of FIG. 41 has been replaced by a motor mount 410 that comprises a first connector 412 and a second connector 414 that are interconnected by with each other by members 416, 418 welded thereto. The first connector 412 and second connector 414 are similar to connector 71A shown in FIGS. 23 and 24, albeit with the solar tube hanger omitted (the solar tube hanger may be connected by screws, bolts, etc). Therefore, the first connector 412 and the second connector 414 each have opposed ears that extend either side of the respective bent tubes to which they are connected. Therefore, the motor mount 410 shown in FIG. 50 has ears located on both sides of both upper support structures, thereby providing a more robust attachment than that shown in FIG. 41, in which ears only extend to one side of each of the upper supports.

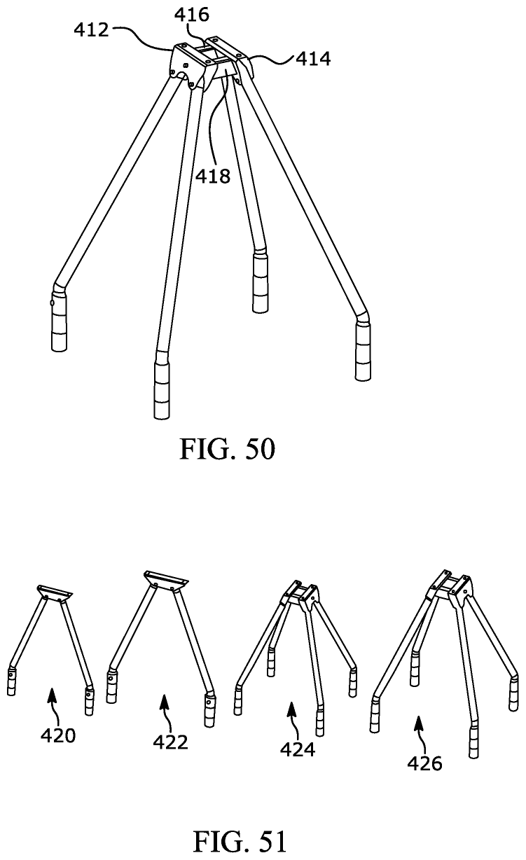

FIG. 51 shows various views of support structures and connectors suitable for use in embodiments of the present invention. In FIG. 51, support structure 420 is similar to the support structure shown in FIG. 48. Support structure 422 is a taller version of the upper support, when compared to the support structure 420. Support structure 424 corresponds to the motor support structure shown in FIG. 50 whilst support structure 426 is a taller version of motor support structure 424.

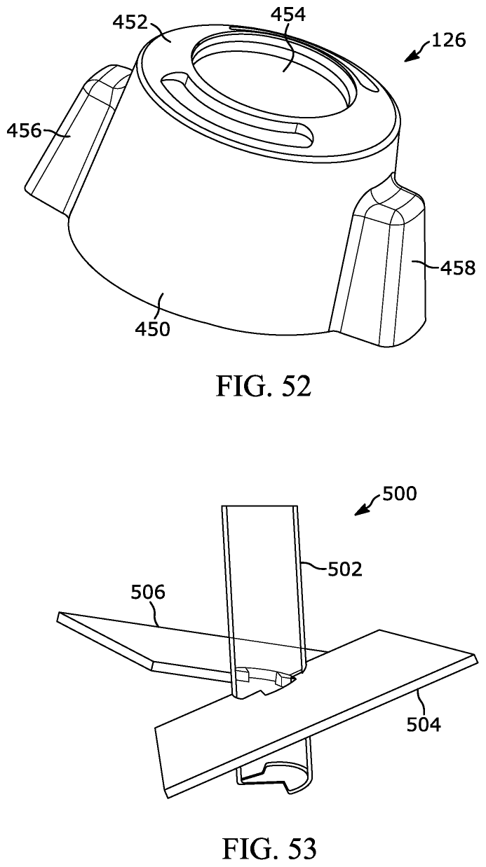

FIG. 52 is a view showing more detail of a protective boot 126 for use in the present invention. The protective boot 126 comprises a downwardly extending peripheral skirt 450 having an inwardly extending flange 452 extending from the top part of the annual peripheral skirt 450. The flange 452 defines an opening 454 that, in use, is dimensioned to snugly fit over the legs of the upper part of support structure. This will assist in avoiding or at least reducing water ingress into the piles once the protective boots have been fitted to the support structure as shown in FIG. 26. The annular peripheral skirt 450 also includes laterally extending extensions 456, 458 that fit over the nuts and bolts (such as bolts 124, 125 shown in FIG. 26) that are used to connect the upper support structure to the piles. The protective boot 450 may be made from a plastic material, a rubber material, or an elastomer.

FIG. 53 shows the lower end of a blade pile 500. The blade pile 500 has a shaft 502 in the form of a hollow cylindrical tube, typically made from mild steel or galvanised steel, although the tube may be made from other materials. The blade pile 500 has two blades 504, 506 affixed thereto, such as by welding. The blades are in the form of plates that are angled relative to each other as shown in FIG. 53. The plates may be made from steel, or a hardened steel, or a hard faced steel, or having cutting edges that have been hard faced or hardened.

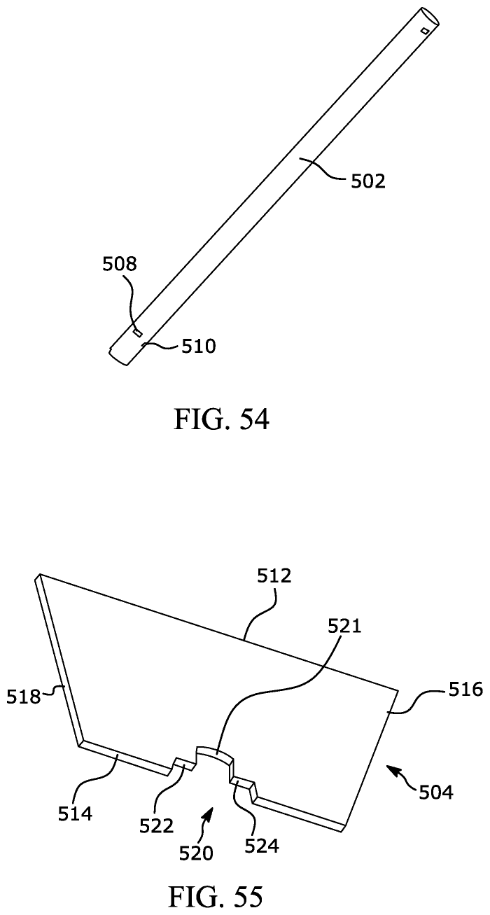

FIG. 54 shows a perspective view of the shaft 502 used in the blade pile 500. As can be seen, the shaft 502 is a cylindrical hollow tube. A plurality of openings, in the embodiment shown in FIG. 54 being 4 openings, is formed in the lower end of the shaft 502. The openings may be laser cut into the shaft. Two of the openings are shown in FIG. 54 at 508, 510. The openings 508, 510 are used to facilitate mounting of the blades 504, 506 to the shaft 502, as will be described hereunder.

FIG. 55 shows blade 504 before it is mounted to the shaft 502. The blade 504 is of general trapezoid shape. The blade 504 has an outer edge 512, an inner edge 514 and side edges 516, 518 (in this context, “inner” and “outer” are used with reference to the position of the blade relative to the shaft in the finished blade pile). The inner edge 514 has a cut-out region 520 having a peripheral region 521 that generally follows the shape of the outer surface of the shaft 502, but with two tabs 522, 524 extending inwardly therefrom. Blade 506 is essentially identical.

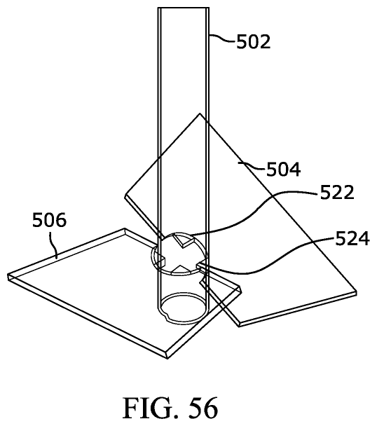

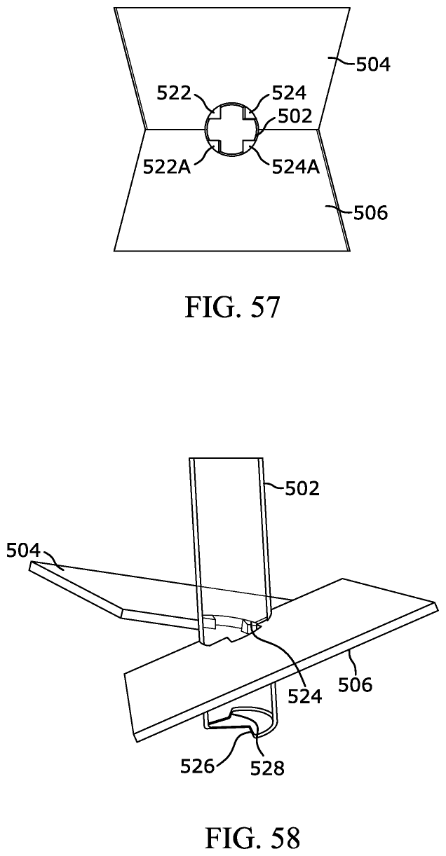

In order to mount the blades 504, 506 to the shaft 502, blade 504 is arranged such that tabs 522, 524 extend into the openings 508, 510 in the lower end of the shaft. The remainder of the peripheral region 521 of the cut out 520 of plate 504 abuts on or is adjacent to the outer surface of the shaft 502. The blade 504 is then welded to the shaft. In the completed blade pile, each blade has two tabs that extend into the internal volume of the shaft 502. This is best shown in FIGS. 56, 57 and 58. In FIG. 57, 322A and 324A are the tabs on blade 506.

As can also be seen in FIG. 58, the lower end of the shaft 502 has sloping shoulders 526, 528. The shoulders act to sweep away soil and stones that have been loosened as the blade pile 500 is driven into the ground.

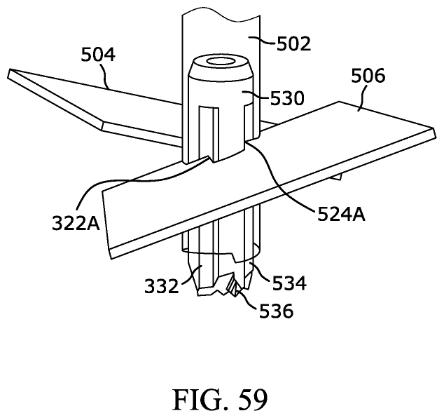

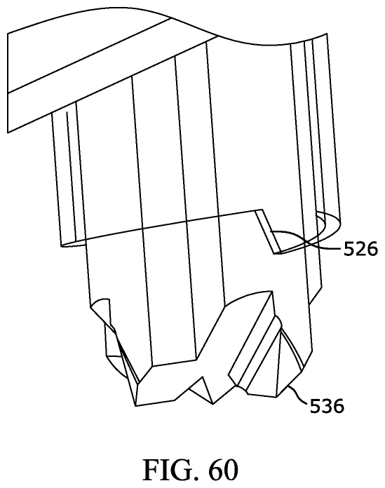

The tabs 522, 524, 522A, 524A that extend from respective blades 504, 506 into the inner volume of the shaft 502 of the completed blade pile 500 provide a drive region that allows the blade pile 500 to be driven into the ground using an appropriate drive tool that can be inserted into the hollow shaft 502 of the blade pile 500. FIGS. 59 and 60 show the lower region 530 of a drive tool. It will be appreciated that the drive tool 530 includes an elongate shaft that is dimensioned to fit within the hollow shaft 502 of the blade pile. The elongate shaft of the drive tube is not shown in FIGS. 59 and 60, but it will be appreciated that the elongate shaft of the drive tool extends directly above the lower end 530 of the drive tool shown in FIGS. 59 and 60. The shaft of the drive tool may be integrally formed with the lower end of the drive tool (in which case, the lower end of the drive tool may be machined in the drive tool shaft), or the lower end of the drive tool may be affixed to the elongate shaft. The elongate shaft of the drive tool may be a hollow shaft or a solid shaft.

The lower end 530 of the drive tool has four longitudinally extending grooves, two of which are shown at 532, 534, machined or otherwise formed therein. The grooves in the drive tool are shaped to be of complementary shape to the tabs 522, 524, 522A, 524A. As can be seen in FIG. 59, when the drive tool is inserted into the blade pile 500, the grooves 532, 534 receive the tabs 522A, 524A. In order to rotate the blade pile 500, the drive tool is rotated which engages the tabs and causes the engaged tabs to also rotate which, in turn, causes the blade pile to rotate.

In order to assist in driving the blade pile 500 into the ground, the lowermost end 536 of the drive tool 530 is shaped as an attack bit which can break through rock and soil. As can be seen from FIGS. 59 and 60, the lowermost end 536 of the drive tool extends below and out of the bottom of the blade pile. FIG. 60 also shows shoulder 526 at the lower end of the blade pile 500, which assists in sweeping away disturbed rock and soil as the blade pile 300 is driven into the ground.

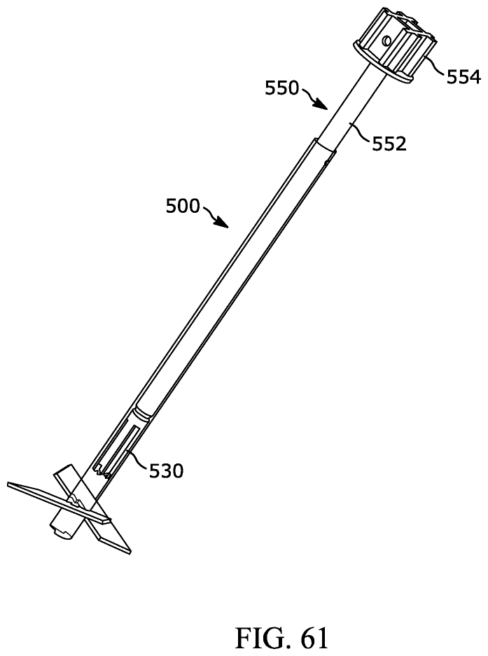

FIG. 61 shows a drive tool 550 having a lower end 530 as shown in FIGS. 59 and 60 partly inserted into the blade pile 500. The shaft 552 of the drive tool 550 can be seen in FIG. 61. A head 554 is attached to the upper end of the drive tool and the head 554 can be fitted into an appropriate tool in a drive head to enable a motor of the drive head to drive/rotate the drive tool.

The arrangement of the blade pile 500 and drive tool 530 allows the blade pile 502 to have force applied to it at the blades as it is driven into the ground. This is in contrast to conventional screw piles where the pile is rotated by drive tool that engages with the top part of the pile and the torsional forces are transmitted through the shaft of the pile, which may require use of a heavier shaft to handle the forces associated with driving the pile into the ground.

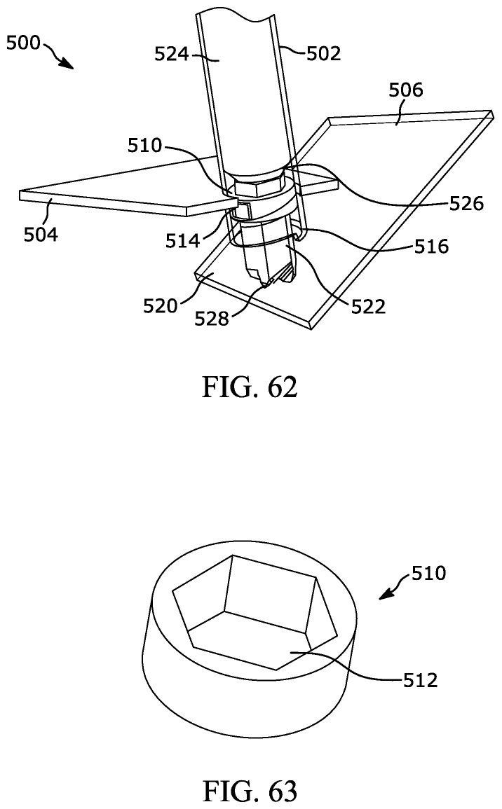

FIG. 62 shows another pile that is suitable for use in preferred embodiments of the present invention. The pile 500 shown in FIG. 62 has a shaft 502 having two blades 504, 506 affixed thereto, such as by welding. The blades are in the form of plates that are angled relative to each other as shown in FIG. 62. A through-ring 510 having a central opening 512 is positioned inside the shaft 502 at a location that is at, near or adjacent to the blades 504, 506. The opening 512 in the through-ring 510 has a hexagonal shape that can engage with a hexagonal drive tool. A perspective view of the through-ring 510 is shown in FIG. 63. The skilled person will appreciate that the opening 512 may have a number of other shapes that can engage with a complementary-shaped drive tool. The through-ring provides an open socket for engaging with the drive tool. The through-ring 510 is welded to the shaft to permanently affix the through-ring to the shaft. For example, a plurality of openings 514 may be cut or formed into the wall of the shaft and weld metal deposited between the openings and the outer diameter of the through-ring in order to weld the through-ring to the shaft of the pile. In the embodiment shown in FIG. 62, four such openings are provided. Shoulder 516 is formed at the lower end of shaft 502 of the pile 500 to sweep away soil and rocks dislodged by the action of screwing the pile 500 into the ground (a second such shoulder is formed diametrically opposite).

The drive tool 520 comprises a lower region 522 having a hexagonal outer shape. The lower region 522 is sized to fit through the opening 512 in the through-ring 510 and for the lower region 522 to engage with the inner surface of the through-ring 510 whereby rotation of the drive tool 520 causes rotation of the pile 500 to thereby drive the pile into the ground. The drive tool 520 has a shaft 524 extending upwardly from the lower region 522 and the shaft 524 can be fitted with an engagement region at its upper end to enable the drive tool to engage with and be rotatably driven, such as by a motor or an auger drive. The drive tool 500 also has a shoulder 526 located above the lower region 522, with the shoulder 526 acting as a stop member to limit insertion of the drive tool into the pile 500. The lower end 528 of the drive tool 500 is formed as an attack bit to enable it to drill into the ground.

Throughout the drawings, ground level is designated by “GL”. Although the embodiment shown in the drawings all have the junction between the tops of the piles and the support legs being above ground, it will be appreciated that this junction may also be located below ground. However, this is not preferred as the limited rotation in the east-west direction will be restricted if the junction point is below ground.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A support for a solar tracker support system, the support including two screw piles or blade piles inserted into the ground, the two screw piles or blade piles being spaced from the longitudinal axis of the solar tracker, and an upper support having a first leg and a second leg and an upper region interconnecting the first leg to the second leg, the first leg mounted to a first pile of the two screw piles or blade piles and extending upwardly therefrom, the second leg mounted to a second pile of the two screw piles or blade piles and extending upwardly therefrom.

2. A support as claimed in claim 1 wherein the upper region of the upper support comprises an arcuate portion or an arched portion.

3. A support as claimed in claim 1 wherein the support further includes a solar tracker mount connected to the upper region of the support.

4. A support as claimed in claim 1 wherein the lower region of the first leg and the lower region of the second leg extend in a substantially vertical direction.

5. A support as claimed in claim 4 wherein the lower regions of the first leg and the second leg comprise separate components that are joined to the first leg and the second leg, or the lower regions of the first leg and second leg are integrally form with the first leg in the second leg.

6. A support as claimed claim 1 wherein the support has a lower region of the first leg that is positioned over an upper region of the first pile and the support has a lower region of the second leg that is positioned over an upper region of the second pile, or the support has a lower region of the first leg that is positioned inside an upper region of the first pile and the support has a lower region of the second leg that is positioned inside an upper region of the second pile.

7. A support as claimed in claim 1 wherein the first leg and the second leg are affixed to the respective first and second piles by use of a bolt or a pin.

8. A support as claimed in claim 1 wherein the solar tracker mount comprises a solar tracker support, a base portion connected to or formed with the solar tracker support, and two opposed ears or plates extending downwardly from the base portion, a first ear or plate located to one side of the upper region of the upper support, a second ear or plate located to another side of the upper region of the upper support, and fasteners to fasten the first ear and the second ear to the upper region of the upper support.

9. A support as claimed in claim 1 wherein the first leg and the second leg of the upper support may be mounted for limited relative rotation between the first leg and the first pile in a direction transverse to a longitudinal axis of the solar tracker and for limited relative rotation between the second leg and the second pile.

10. A support as claimed in claim 9 wherein the open lower end on the first support has an opening having a larger dimension in the direction transverse to the longitudinal axis (the “east-west direction”) than an outside diameter or outside dimension of the shafts of the piles, and the opening of the lower end of the first support has an inner dimension in a direction parallel to the longitudinal axis of the solar tracker (the “north-south direction”) that is similar to the outer dimension of the first pile, with the second support and second pile being similarly arranged.

11. A support as claimed in claim 10 wherein the lower openings comprise tubes that are flattened on the north-south faces, or the openings are of generally oval shape or the openings are of rectangular shape and the north-south dimension is smaller than the east-west dimension.

12. A support as claimed in claim 9 wherein the first support is hingedly mounted to the first screw pile or the first support is pivotally mounted to the first screw pile, the first support being pivotally mounted to the first pile by a pin or a bolt that extends along a north-south direction, and wherein the second support is hingedly mounted to the second screw pile or the second support is pivotally mounted to the second screw pile, the second support being pivotally mounted to the second pile by a pin or a bolt that extends along a north-south direction

13. A support as claimed in claim 9 wherein a lower end of a first support has flattened north and south faces and the flattened north and south faces of the lower end have substantially the same dimension as the diameter of the shaft of a pile such that an interference fit is established and the east and west faces of the lower end of the first support have a larger dimension than a diameter of the shaft of the pile, wherein the ends of first support enable east-west movement of the first support relative to the shaft of the pile, and wherein a lower end of the second support has flattened north and south faces and the flattened north and south faces of the lower end have substantially the same dimension as the diameter of the shaft of a pile such that an interference fit is established and the east and west faces of the lower end of the second support have a larger dimension than a diameter of the shaft of the pile, wherein the ends of second support enable east-west movement of the second support relative to the shaft of the pile.

14. A support as claimed in claim 9 wherein the lower end of the first support is received within the open upper end of the first pile and the first pile has a larger dimension in the east-west direction than in the north-south direction and the first support has an outer dimension in the north-south direction that is very close to the inner dimension in the north-south direction of the first pile, and wherein the lower end of the second support is received within the open upper end of the second pile and the second pile has a larger dimension in the east-west direction than in the north-south direction and the second support has an outer dimension in the north-south direction that is very close to the inner dimension in the north-south direction of the second pile.

15. A support system as claimed in claim 1 wherein the screw piles or blade piles are inserted substantially vertically into the ground.

16. A support system for a solar tracker including a plurality of supports as claimed in claim 1, the supports being spaced from each other and extending along a longitudinal axis of the solar tracker.

17. A support system as claimed in claim 16 wherein a motor mount is mounted to two adjacent supports.

18. A support system as claimed in claim 17 wherein the motor mount is mounted to two adjacent supports, each support comprising two screw piles or blade piles inserted into the ground, the two screw piles or blade piles being spaced longitudinally from the longitudinal axis of the solar tracker, and an upper support having a first leg and a second leg and an upper region interconnecting the first leg to the second leg, the first leg mounted to a first pile of the two screw piles or blade piles and extending upwardly therefrom, the second leg mounted to a second pile of the two screw piles or blade piles and extending upwardly therefrom, the first leg extending upwardly and inwardly towards a longitudinal axis of a solar tracker mounted thereto and also extending towards the adjacent support.

19. A support system as claimed in claim 18 wherein the motor mount comprises a bracket having an upper surface for mounting the motor thereto and downwardly extending side surfaces, one side surface extending down over a first leg and a second leg and an opposed side surface extending over an adjacent first leg and an adjacent second leg.

20. A support system as claimed in claim 16 wherein the motor mount includes a motor mounting plate having bolt holes for receiving mounting bolts to mount a motor thereto.

21. A support system for a solar tracker including a plurality of supports spaced from each other and extending along a longitudinal axis of the solar tracker, the supports including two screw piles or blade piles inserted into the ground, the two screw piles or blade piles being spaced longitudinally from the longitudinal axis of the solar tracker, a first support mounted to a first pile of the two screw piles or blade piles and extending upwardly therefrom, a second support mounted to a second pile of the two screw piles or blade piles and extending upwardly therefrom, an upper region of the first support extending inwardly towards the longitudinal axis of the solar tracker, an upper region of the second support extending inwardly towards the longitudinal axis of the solar tracker, and a connector connecting the upper end of the first support to the upper end of the second support.

22. A support system as claimed in claim 21 wherein the screw piles or blade piles are inserted substantially vertically into the ground.

23. A support system as claimed in claim 21 wherein the upper region of the first support and the second support comprises an essentially straight region.

24. A support system as claimed in claim 21 wherein the first support comprises a lower region having an open lower end, the lower region extending in a generally vertical direction, the lower region being located over an upper end of the first pile, the first support extending upwardly and inwardly from the lower region, and the second support comprises a lower region having an open lower end, the lower region extending in a generally vertical direction, the lower region being located over an upper end of the second pile, the second support extending upwardly and inwardly from the lower region.

25. A support for a solar tracker support system, the support including two screw piles or blade piles inserted into the ground, the two screw piles or blade piles being spaced longitudinally from the longitudinal axis of the solar tracker, a first support mounted to a first pile of the two screw piles or blade piles and extending upwardly therefrom, a second support mounted to a second pile of the two screw piles or blade piles and extending upwardly therefrom, an upper region of the first support extending inwardly towards the longitudinal axis of the solar tracker, an upper region of the second support extending inwardly towards the longitudinal axis of the solar tracker, and a connector connecting the upper end of the first support to the upper end of the second support.

26. A blade pile comprising a hollow shaft, a first blade mounted near a lower end of the hollow shaft and a second blade mounted at near the lower end of the hollow shaft, the first blade having a plurality of tabs extending through respective openings in a side wall of the hollow shaft, the second blade having a plurality of tabs extending through respective openings in a side wall of the hollow shaft, the first blade and the second blade being affixed to the hollow shaft.
